(19) United States
(12) Patent Application Publication
(10) Pub. No.: US 2024/0367986 A1
(43) Pub. Date: Nov. 7, 2024

(54) CHA-DDR TYPE ZEOLITE MEMBRANE AND METHOD FOR MANUFACTURING THE SAME

(71) Applicant: KOREA UNIVERSITY RESEARCH AND BUSINESS FOUNDATION, Seoul (KR)

(72) Inventors: Jung-Kyu CHOI, Seoul (KR); Kwan-Young LEE, Seoul (KR); Yang-Hwan JEONG, Seoul (KR); Se-Jin KIM, Seoul (KR)

(73) Assignee: Korea University Research and Business Foundation, Seoul (KR)

(21) Appl. No.: 18/552,567

(22) PCT Filed: Oct. 31, 2022
(86) PCT No.: PCT/KR2022/016775

§ 371 Date: Sep. 26, 2023

(30) Foreign Application Priority Data
Nov. 1, 2021 (KR) 10-2021-0147656
Oct. 28, 2022 (KR) 10-2022-0141431

(51) Int. Cl. C01B 39/04; B01D 53/22; B01D 69/04; B01D 69/10; B01D 71/02

(52) U.S. Cl. CPC C01B 39/04; B01D 69/04; B01D 69/10; B01D 71/0281; B01D 53/228; B01D 2257/504; C01P 2002/74

(57) ABSTRACT

The present disclosure may provide a CHA-DDR type zeolite membrane including: a first layer including a CHA structure and a DDR structure; and a second layer which is provided on the first layer and includes a DDR structure, wherein the CHA-DDR type zeolite membrane is in the form of a film having a thickness of 100 nm to 5 μm, including a CHA structure and a DDR structure.

### TECHNICAL FIELD

The present disclosure relates to a CHA-DDR type zeolite membrane and a method for manufacturing the same, and more particularly, to a CHA-DDR type zeolite membrane having a high permeance and thin thickness using a novel manufacturing method, and a method for manufacturing the same.

### BACKGROUND ART

Zeolites are catalysts for conversion of methanol to gasoline or denitrification of smoke, and are alumina-silica crystal molecular sieves in which tetrahedrons of SiO₄ and AlO₄⁻ are combined in a geometric shape to have a regular three-dimensional framework structure, wherein the tetrahedrons are connected by sharing oxygen with each other, and the skeleton is characterized by having channels and also having cavities connected to each other. Due to these characteristics, since zeolites have excellent ion exchange properties, they are used for various purposes such as catalysts, adsorbents, molecular sieves, ion exchangers, and membranes.

Meanwhile, in the case of zeolite membranes for separating mixed gases, despite their high potential capable of capturing carbon dioxide, they are difficult to use in actual industries and processes. This is because conventional manufacturing methods cannot reproducibly manufacture zeolite membranes having high performances.

Therefore, various studies are being conducted on methods for reproducibly manufacturing large-area zeolite membranes having high permeances and high gas separation performances.

### Prior Document

Korean Patent No. 10-0861012

### DISCLOSURE

### Technical Problem

An object of the present disclosure is to provide a CHA-DDR type zeolite membrane capable of effectively separating carbon dioxide and a method for manufacturing the same.

Furthermore, another object of the present disclosure is to provide a CHA-DDR type zeolite membrane which has high reproducibility and is easy to manufacture in a large area, and thus has improved industrial use, and a method for manufacturing the same.

### Technical Solution

According to one aspect of the present disclosure, embodiments of the present disclosure include a CHA-DDR type zeolite membrane including: a first layer including a CHA structure and a DDR structure; and a second layer which is provided on the first layer and includes a DDR structure, wherein the CHA-DDR type zeolite membrane is in the form of a film having a thickness of 100 nm to 5 μm and includes a CHA structure and a DDR structure.

In one embodiment, the second layer may include a pyramid-shaped surface portion, and a (101) plane peak may appear during XRD measurement using CuKα rays.

In one embodiment, the first layer may have an average thickness of 50 nm to 2 μm, and the second layer may have an average thickness of 10 nm to 2 km.

In one embodiment, the CHA structure of the first layer may be made of a CHA precursor solution, the CHA precursor solution may contain a first organic structure-directing agent, SiO₂, H₂O, a sodium compound, and an aluminum compound, and the first organic structure-directing agent, SiO₂, H₂O, sodium compound, and aluminum compound may have molar ratios of 0.1 to 1,000:100:100 to 50,000:0 to 500:0 to 100, respectively.

In one embodiment, the first organic structure-directing agent may be any one or more of N,N,N-trimethyl adamantylammonium hydroxide (TMAdaOH), N,N,N-trimethyl adamantylammonium bromide (TMAdaBr), N,N,N-trimethyl adamantylammonium fluoride (TMAdaF), N,N,N-trimethyl adamantylammonium chloride (TMAdaCl), N,N,N-trimethyl adamantylammonium iodide (TMAdaI), tetraethylammonium hydroxide (TEAOH), tetraethylammonium bromide (TEABr), tetraethylammonium fluoride (TEAF), tetraethylammonium chloride (TEACl), tetraethylammonium iodide (TEAI), dipropylamine, and cyclohexylamine.

In one embodiment, the DDR structure of the first layer or the second layer may be made of a DDR precursor solution, the DDR precursor solution may contain SiO₂, a second organic structure-directing agent, H₂O, a sodium compound, and an aluminum compound, and SiO₂, second organic structure-directing agent, H₂O, sodium compound, and aluminum compound may have molar ratios of 100:1 to 1,000:10 to 100,000:0 to 500:0 to 100, respectively.

In one embodiment, the second organic structure-directing agent may be any one or more of methyltropinium iodide, methyltropinium bromide, methyltropinium fluoride, methyltropinium chloride, methyltropinium hydroxide, quinuclidinium, tetraethylammonium hydroxide (TEAOH), tetraethylammonium bromide (TEABr), tetraethylammonium fluoride (TEAF), tetraethylammonium chloride (TEACl), tetraethylammonium iodide (TEAI), ethylenediamine, and adamantylamine.

In one embodiment, the CHA-DDR type zeolite membrane may have a carbon dioxide permeance of 1×10⁻⁹ mol·m⁻²·s⁻¹·Pa⁻¹ to 1×10⁻⁵ mol·m⁻²·s⁻¹·Pa⁻¹.

In one embodiment, the CHA structure may be included in 25 parts by weight to 95 parts by weight based on 100 parts by weight of the total crystal structure of the CHA structure and the DDR structure of the first layer and the second layer.

In one embodiment, when carbon dioxide and methane are mixed gases with a molar ratio of 50:50, carbon dioxide may have a recovery of 10% to 100% and a purity of 50% to 100%, and methane may have a recovery of 50% to 100% and a purity of 30% to 100%.

In one embodiment, when carbon dioxide and nitrogen are mixed gases with a molar ratio of 15:85, carbon dioxide may have a recovery of 10% to 100% and a purity of 20% to 100%, and nitrogen may have a recovery of 30% to 100% and a purity of 30% to 100%.

In one embodiment, the CHA-DDR type zeolite membrane may separate a mixture of gas and gas, a mixture of gas and liquid, and a mixture of liquid and liquid.

In one embodiment, there may be included a method for manufacturing a CHA-DDR type zeolite membrane, the method including: a first growth step of forming seed particles including a CHA structure prepared by a hydrothermal synthesis method using a CHA precursor solution containing a first organic structure-directing agent; and a second growth step of forming a layered structure including a DDR structure to cover the seed particles by the hydrothermal synthesis method using a DDR precursor solution containing a second organic structure-directing agent, wherein the CHA-DDR type zeolite membrane is in the form of a film having a thickness of 100 nm to 5 μm, and includes a CHA structure and a DDR structure.

In one embodiment, the first growth step may include synthesizing the seed particles including the CHA structure by the hydrothermal synthesis method using the CHA precursor solution, dispersing the seed particles in a solvent to prepare a suspension, impregnating a support in the suspension to coat the surface of the support with the seed particles, drying the support coated with the seed particles, and calcining the support coated with the seed particles at 300° C. to 550° C. for 1 hour to 24 hours after completing drying.

In one embodiment, the second growth step may include adding the DDR precursor solution and the support coated with the seed particles and performing hydrothermal synthesis.

In one embodiment, in the first growth step, the seed particles may be provided in the form of a plurality of particles on a support, and the support may include any one or more of α-alumina, γ-alumina, polypropylene, polyethylene, polytetrafluoroethylene, polysulfone, polyimide, silica, glass, mullite, zirconia, titania, yttria, ceria, vanadia, silicon, stainless steel, carbon, calcium oxide, and phosphorus oxide.

In one embodiment, the support may be provided in a high permeance tubular shape with a permeance of 1×10⁻⁶ mol·m⁻²·s⁻¹·Pa⁻¹ to 1×10⁻⁴ mol·m⁻²·s⁻¹·Pa⁻¹.

In one embodiment, the seed particles may be formed in plurality, and the seed particles may have an average length of 10 nm to 1 μm.

In one embodiment, the hydrothermal synthesis method in the first growth step may be performed for 6 hours to 400 hours and in a temperature range of 100° C. to 250° C.

In one embodiment, the hydrothermal synthesis method in the secondary growth step may be performed for 6 hours to 400 hours and at 100° C. to 250° C.

In one embodiment, the CHA precursor solution and the DDR precursor solution may each contain Si and Al, the CHA structure may have a Si:Al molar ratio reference value of 100:0 to 10, and the DDR structure may have a Si:Al molar ratio reference value of 100:0 to 10.

In one embodiment, after the second growth step, a calcination step may be further included, and the calcination step may be performed in a temperature range of 100° C. to 300° C. in an ozone atmosphere.

In one embodiment, the CHA-DDR type zeolite membrane may contain 1% by weight or less of adamantylamine in pores thereof.

### Advantageous Effects

According to the present disclosure as described above, it may be possible to provide a CHA-DDR type zeolite membrane which has excellent carbon dioxide separation performance and is capable of separating carbon dioxide with high purity and a method for manufacturing the same.

Further, according to the present disclosure, it may be possible to provide a CHA-DDR type zeolite membrane which can be manufactured with high reproducibility in a large area and thus is easy to be applied industrially by applying a novel method, and a method for manufacturing the same.

### DESCRIPTION OF DRAWINGS

FIG. 1 is a schematic diagram schematically showing a method for manufacturing a CHA-DDR type zeolite membrane according to one embodiment of the present disclosure.

FIG. 2 shows schematic forms of a cell and a module for evaluation of separation performance.

FIG. 3 shows SEM images, XRD patterns, a STEM image, and electron diffraction patterns of the CD membrane according to this embodiment.

FIG. 4 shows a STEM image and an electron diffraction pattern of the CD membrane according to this embodiment.

FIG. 5 shows electron diffraction patterns of the marked portions of the STEM image of FIG. 4.

FIG. 6 shows SEM images and XRD patterns according to calcination conditions of CD-P particles according to the embodiment of the present disclosure.

FIG. 7 is SEM images and FCOM images of CD membranes according to air calcination and ozone calcination.

FIG. 8 is SEM images according to calcination conditions of a CD membrane.

FIG. 9 is results of confirming the CO₂/CH₄ separation performances of the CD membranes manufactured by air calcination and ozone calcination, respectively.

FIG. 10 is results of evaluating the separation performances of CO₂/CH₄ for CD-1-Cell and CD-4-Module.

FIG. 11 is a result of confirming the long-term stability of CD-1-Cell.

FIG. 12 is results of showing permeance and SF of a CO₂/CH₄ binary equimolar mixed gas for a plurality of CD membranes.

FIG. 13 is results showing the separation performances of CD-1-Cell for a CO₂/N₂ mixture.

FIG. 14 shows results of showing the separation performances of CD-1-Cell for a CO₂/N₂ mixture under dry and wet conditions.

FIG. 15 is results showing the separation performances of CD-1-Cell for a CO₂/N₂ mixture according to temperature conditions.

FIG. 16 is results of evaluating the separation performances of CO₂/CH₄ for CD-1-Cell and CD-4-Module.

FIG. 17 is graphs showing the recovery and purity under dry and wet conditions of FIG. 16.

FIG. 18 is results of comparing performances of CD-1-Cell, CD-4-Module, and other membranes.

FIG. 19 shows schematic features of the other membranes of FIG. 18.

FIG. 20 is results of evaluating liquid separation performances using an ozone-calcined CD membrane.

### MODES OF THE INVENTION

Details of other embodiments are included in the detailed description and drawings.

Advantages and features of the present disclosure, and methods of achieving t hem, will become clear with reference to the detailed description of the following embodiments taken in conjunction with the accompanying drawings. However, the present disclosure is not limited to the embodiments disclosed below, but may be implemented in various different forms, and since, unless otherwise specified in the following description, these numbers are essentially approximations that reflect the various uncertainties of measurement that arise in obtaining these values among other things, it should be understood that all numbers, values and/or expressions expressing components, reaction conditions, or amounts of the components in the present disclosure are in all instances modified by the term “about”. Also, when a numerical range is disclose d in the present description, such a range is continuous and includes all values in such a range from a minimum value to the maximum value including a maximum value, unless otherwise indicated. Furthermore, when such a range refers to an integer, all integers including from the minimum value to the maximum value including a maximum value are included unless otherwise indicated.

Further, when a range is stated for a variable in the present disclosure, it will be understood that the variable includes all values within the stated range including the stated endpoints of the range. For example, a range of “5 to 10” includes any subrange of 6 to 10, 7 to 10, 6 to 9, 7 to 9, and the like as well as values of 5, 6, 7, 8, 9, and 10, and it will be understood also to include any value between integers that fall within the scope of the stated range, such as 5.5, 6.5, 7.5, 5.5 to 8.5, 6.5 to 9, and the like. For example, a range of “10% to 30%” includes any subrange of 10% to 15%, 12% to 18%, 20% to 30%, and the like as well as values such as 10%, 11%, 12%, 13% and the like, and all integers including up to 30%, and it will be understood also to include any value between integers that fall within the scope of the stated range, such as 10.5%, 15.5%, 25.5%, and the like.

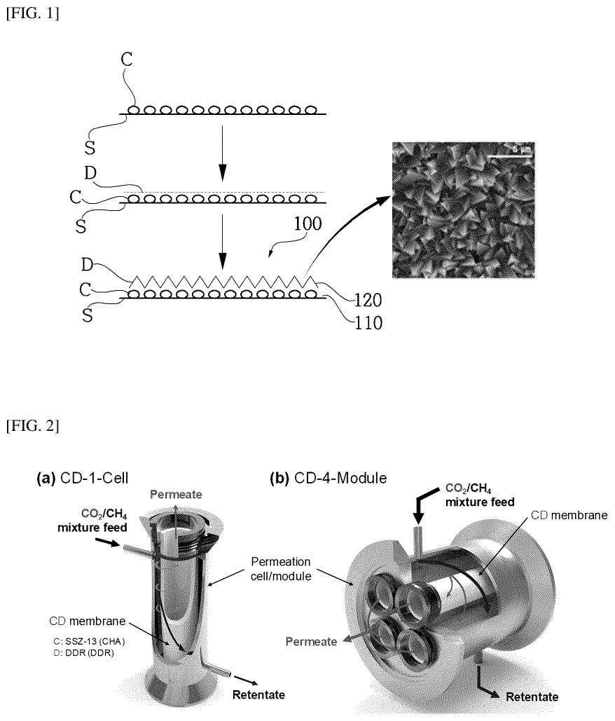

FIG. 1 is a schematic diagram schematically showing a method for manufacturing a CHA-DDR type zeolite membrane according to one embodiment of the present disclosure.

Referring to FIG. 1, the CHA-DDR type zeolite membrane 100 including a chabazite (CHA) structure and a deca-dodecasil 3 rhombohedral (DDR) structure according to one embodiment of the present disclosure may be in the form of a film including: a first layer 110 including a CHA structure (c) and a DDR structure (d); and a second layer 120 which is provided on the first layer 110 and includes a DDR structure (d), and having a thickness of 100 nm to 5 μm. The second layer 120 may include a pyramid-shaped surface portion, and a (101) plane peak may appear during XRD measurement using CuKα rays.

In general, biogas is an environmentally friendly and sustainable energy resource that can replace or supplement conventional fossil fuels. On the other hand, in order to use biogas, it is necessary to upgrade biogas by effectively separating CO₂ (0.33 nm) and CH₄ (0.38 nm). In this way, a DDR zeolite membrane may be used in order to upgrade biogas, but the DDR zeolite membrane has a problem in that a method for manufacturing the DDR zeolite membrane is difficult. Specifically, in order to manufacture the DDR zeolite membrane, the size of the seed particles is large, the synthesis time is long, and since it is difficult to secure reproducibility of the synthesis, commercial application has been limited. Accordingly, the conventional DDR zeolite membrane may effectively separate gases such as CO₂ and CH₄ contained in biogas, but it has been difficult to manufacture it as a membrane having a thin film thickness.

Meanwhile, the CHA-DDR type zeolite membrane 100 according to this embodiment has improved separation ability compared to the conventional DDR zeolite membrane, has high reproducibility of the manufacturing method, and is easy to commercialize since it can be manufactured with a thinner film thickness.

The CHA-DDR type zeolite membrane 100 according to this embodiment may be comprised of a first layer 110 including the CHA structure (c) and the DDR structure (d) and a second layer 120 which is provided on the first layer 110 and includes the DDR structure (d). For example, it may include the first layer 110 and the second layer 120, the thickness of the first layer 110 and the second layer 120 may be controlled, and the entire CHA-DDR type zeolite membrane 100 including the first layer 110 and the second layer 120 may be provided in the form of a film having a thickness of 100 nm to 5 μm.

Further, the CHA-DDR type zeolite membrane 100 may be provided in a tubular shape or a tube shape, and a plurality of membranes formed in a tubular shape may be connected to each other to be used for upgrading biogas or separating mixed gases. Since the CHA-DDR type zeolite membrane 100 is provided in a tubular shape or a tube shape so that the CHA-DDR type zeolite membrane 100 may be designed in the form of a single cell, or may be manufactured even in the form of a module composed of a plurality of cells, it can be more efficiently applied to the actual process. The separation efficiency of gas can be further improved by separating the mixed gases through the inner cavity of the membrane formed in the tubular shape.

Specifically, the CHA-DDR type zeolite membrane 100 may form seed particles including the CHA structure (c) on the support (s). The CHA-DDR type zeolite membrane 100 including the first layer 110 and the second layer 120 may be formed by performing secondary growth of zeolite including the DDR structure (d) using the seed particles.

When the CHA-DDR type zeolite membrane 100 has a thickness of less than 100 nm, it is difficult to obtain high-purity CO₂, and in particular, in the case of mixed gases containing water vapor, there is a problem in that separation is difficult. When the thickness exceeds 5 μm, the size and processing cost of the device using the CHA-DDR type zeolite membrane 100 increase, and the contents of the mixed gases that can be processed at one time also decrease. In addition, in the case of a conventional DDR zeolite membrane, it was difficult to manufacture a membrane with a thickness of 7 μm or less due to limitations in the method of synthesizing DDR zeolite, but since it is possible to manufacture the CHA-DDR type zeolite membrane 100 according to this embodiment at a thickness of 5 μm or less, the separation ability and separation efficiency of the mixed gases can be further improved.

The first layer 110 may have an average thickness of 50 nm to 2 μm, and the second layer 120 may have an average thickness of 10 nm to 2 μm. If the first layer 110 has an average thickness of less than 50 nm, since it is difficult to form a stable CHA seed structure, it is difficult to grow a second layer 120 formed of the DDR structure (d) on the first layer 110, If the first layer 110 has an average thickness exceeding 2 μm, the thickness of the overall CHA-DDR type zeolite membrane 100 unnecessarily increases. In addition, it may possible to effectively upgrade biogas and separate high-purity CO₂ by providing the second layer 120 with the aforementioned thickness.

The first layer 110 is a layer in which the CHA structure (c) and the DDR structure (d) are mixed, and the content of the CHA structure (c) and the DDR structure (d) having different pore sizes and physical properties can be controlled. In addition, the second layer 120 may be formed of only the DDR structure (d), and may include a pyramid-shaped surface portion on the outermost surface of the second layer 120. In addition, a peak on the (101) plane may appear in the CHA-DDR type zeolite membrane 100 during XRD measurement using CuKα rays.

For example, the CHA-DDR type zeolite membrane 100 according to this embodiment is manufactured by a novel method, and thus it may have XRD peaks of the (101) plane, which is a characteristic of the CHA structure (c) only, at the same time while having a pyramid-shaped surface portion, which is a characteristic of the DDR structure (d) only. In addition, the CHA-DDR type zeolite membrane 100 according to this embodiment can be reproducibly manufactured with a thickness thinner than the conventional DDR zeolite membrane, and can have improved biogas upgrade performance and mixed gas separation ability.

The CHA structure may be included in 25 parts by weight to 95 parts by weight with respect to 100 parts by weight of the total crystal structure of the CHA structure and the DDR structure of the first layer 110 and the second layer. In general, zeolite may be manufactured in the form of a film composed only of the same crystal structure through second growth using seed particles having the same crystal structure. Meanwhile, in this embodiment, by controlling the seed particles including the CHA structure within the above-described range, the DDR structure may be secondly grown and manufactured in the form of a thin film.

The CHA structure of the first layer 110 may be made of a CHA precursor solution. The CHA precursor solution may include a first organic structure-directing agent, SiO₂, H₂O, a sodium compound, and an aluminum compound. For example, the sodium compound may include sodium oxide or sodium hydroxide, and specifically, may be Na₂O₃ or NaOH. In addition, the aluminum compound may include aluminum oxide or aluminum hydroxide, and specifically, may be Al₂O₃ or Al(OH)₃.

The first organic structure-directing agent, SiO₂, H₂O, the sodium compound, and the aluminum compound may have molar ratios of 0.1 to 1,000:100:100 to 50,000:0 to 500:0 to 100, respectively. Specifically, the first organic structure-directing agent, SiO₂, H₂O, the sodium compound, and the aluminum compound may have molar ratios of 1 to 100:100:500 to 30,000:5 to 50:0.5 to 20, more specifically 20:100:1,600:20:5, respectively.

The first organic structure-directing agent may be any one or more of N,N,N-trimethyl adamantylammonium hydroxide (TMAdaOH), N,N,N-trimethyl adamantylammonium bromide (TMAdaBr), N,N,N-trimethyl adamantylammonium fluoride (TMAdaF), N,N,N-trimethyl adamantylammonium chloride (TMAdaCl), N,N,N-trimethyl adamantylammonium iodide (TMAdaI), tetraethylammonium hydroxide (TEAOH), tetraethylammonium bromide (TEABr), tetraethylammonium fluoride (TEAF), tetraethylammonium chloride (TEACl), tetraethylammonium iodide (TEAI), dipropylamine, and cyclohexylamine.

The DDR structure (d) of the first layer 110 or the second layer 120 may be made of a DDR precursor solution. The DDR precursor solution may include SiO₂, a second organic structure-directing agent, H₂O, a sodium compound, and an aluminum compound. For example, the sodium compound may include sodium oxide or sodium hydroxide, and specifically, may be Na₂O₃ or NaOH. In addition, the aluminum compound may include aluminum oxide or aluminum hydroxide, and specifically, may be Al₂O₃ or Al(OH)₃.

SiO₂, the second organic structure-directing agent, H₂O, the sodium compound, and the aluminum compound may have molar ratios of 100:1 to 1,000:10 to 100,000:0 to 500:0 to 100, respectively. Specifically, SiO₂, the second organic structure-directing agent, H₂O, the sodium compound, and the aluminum compound may have molar ratios of 100:10 to 800:500 to 30,000:0 to 50:0 to 20, more specifically 100:450:11,240:0: 0, respectively.

The second organic structure-directing agent may be any one or more of methyltropinium iodide, methyltropinium bromide, methyltropinium fluoride, methyltropinium chloride, methyltropinium hydroxide, quinuclidinium, tetraethylammonium hydroxide (TEAOH), tetraethylammonium bromide (TEABr), tetraethylammonium fluoride (TEAF), tetraethylammonium chloride (TEACl), tetraethylammonium iodide (TEAI), ethylenediamine, and adamantylamine.

Specifically, the second organic structure-directing agent may be used in combination of two or more materials, and more specifically, adamantylamine and one or more other materials may be used in combination. For example, the second organic structure-directing agent may include adamantylamine and ethylenediamine, and when adamantylamine and ethylenediamine are used in a combination, ethylenediamine may be used 5 times to 20 times the molar ratio with respect to adamantylamine. In addition, adamantylamine and ethylenediamine may be used in a combination of a molar ratio of 10 to 100:50 to 1,000.

The CHA-DDR type zeolite membrane 100 may be manufactured by forming seed particles with the CHA precursor solution and then performing second growth thereof with the DDR precursor solution, and a structurally stable zeolite can be used by using the CHA precursor solution and the DDR precursor solution within the above-described range.

In general, a zeolite membrane is usually manufactured using a secondary growth method. At this time, the crystal structures of zeolite constituting the seed particles and zeolite constituting the entire membrane should be the same. When synthesizing ZSM-58 zeolite having a DDR structure by using methyltropinium iodide, a commonly used method, as an organic structure-directing agent (OSDA), seed particles are formed very large, where when manufactured in the form of a film by secondary growth, the thickness of the manufactured film was too thick so that there was a problem in that transmittance decreased.

Meanwhile, in this embodiment, a CHA-DDR type zeolite membrane 100 which controls the size of the seed particles to be small, can be manufactured in the form of a thin film, and at the same time, and includes both the CHA structure and the DDR structure by using the CHA precursor solution and the DDR precursor solution may be manufactured. Specifically, the first organic structure-directing agent may include methyltropinium iodide or 1-adamantylamine (ADA), and the second organic structure-directing agent may be 1-adamantylamine (ADA) or ethylenediamine.

The CHA-DDR type zeolite membrane 100 may have a carbon dioxide permeance of 1×10⁻⁹ mol·m⁻²·s⁻¹·Pa⁻¹ to 1×10⁻⁵ mol·m⁻²·s⁻¹·Pa⁻¹.

In addition, the CHA-DDR type zeolite membrane 100 includes separating carbon dioxide (CO₂) gas from a gas mixture, and an inflow rate of the gas mixture may be 25 ml/min to 4,000 ml/min.

In the case of mixed gases in which carbon dioxide and methane are mixed at a molar ratio of 50:50, the CHA-DDR type zeolite membrane 100 may have a recovery of carbon dioxide of 10% to 100% and a purity of carbon dioxide of 50% to 100%, and may have a recovery of methane of 50% to 100% and a purity of methane of 30% to 100%.

Further, in the case of mixed gases in which carbon dioxide and nitrogen are mixed at a molar ratio of 15:85, the CHA-DDR type zeolite membrane 100 may have a recovery of carbon dioxide of 10% to 100% and a purity of carbon dioxide of 20% to 100%, and may have a recovery of nitrogen of 30% to 100%, and a purity of nitrogen of 30% to 100%.

The CHA-DDR type zeolite membrane 100 according to this embodiment may be manufactured with a thickness in the above-described range, and may achieve the above-described range of carbon dioxide permeance at the inflow rate of the above-described gas mixture by including the first layer 110 including the CHA structure (c) and the DDR structure (d) and the second layer 120 consisting of only the DDR structure (d).

The CHA-DDR type zeolite membrane may separate a mixture of gas and gas, a mixture of gas and liquid, and a mixture of liquid and liquid. Specifically, it may separate materials that are difficult to separate from each other, such as mixtures of materials having similar molecular sizes or polar materials, and mixtures of non-polar materials. In addition, the CHA-DDR type zeolite membrane may separate not only mixtures composed of different phases of gas and liquid, but also mixtures of gases and gases, and mixtures of liquids and liquids with high separation performance. Specifically, in the mixtures of liquids and liquids, the liquids may be all composed of polar materials or non-polar materials.

For example, each of the mixture of gas and gas, the mixture of gas and liquid, and the mixture of liquid and liquid may be composed of two or more materials. For example, in the mixture of gas and gas, one or two gases may be simultaneously separated from a material in which three or more gases are mixed.

According to another aspect of the present disclosure, embodiments of the present disclosure may include a method for manufacturing a CHA-DDR type zeolite membrane, the method including: a first growth step of forming seed particles including a CHA structure prepared by a hydrothermal synthesis method using a CHA precursor solution containing a first organic structure-directing agent; and a second growth step of forming a layered structure including a DDR structure to cover the seed particles by the hydrothermal synthesis method using a DDR precursor solution containing a second organic structure-directing agent. The CHA-DDR type zeolite membrane may include a CHA structure and a DDR structure, and may be provided in the form of a film having a thickness of 100 nm to 5 μm.

The first growth step may include synthesizing the seed particles including the CHA structure by the hydrothermal synthesis method using the CHA precursor solution, dispersing the seed particles in a solvent to prepare a suspension, impregnating a support in the suspension to coat the surface of the support with the seed particles, drying the support coated with the seed particles, and calcining the support coated with the seed particles at 300° C. to 550° C. for 1 hour to 24 hours after completing drying.

The support may include a tubular support in the form of a pipe having a space therein, and the seed particles may be provided on an outer surface of the support by dip coating. For example, when the support is provided as a tubular support having a space therein, one end and the other end thereof may be covered, respectively, before being impregnated into the suspension, thereby preventing the seed particles from being coated on the inside of the tubular support.

The solvent may include any one or more of ethanol, methanol, butanol, isopropanol, toluene, xylene, benzene, methylene chloride, chloroform, dioxane, tetrahydrofuran (THF), acetone, dimethyl sulfoxide (DMSO), dimethylformamide (DMF), 1-methyl-2-pyrrolidone (NMP), and deionized water. Specifically, the solvent may be ethanol or deionized water.

The suspension may include 0.001 parts by weight to 0.5 parts by weight of seed particles based on 100 parts by weight of the suspension. When the seed particles are included in an amount of less than 0.001 parts by weight, since the amount of the seed particles coated on the surface of the tubular support is too small, it may cause problems during secondary growth, and when the seed particles are included in an amount of exceeding 0.5 parts by weight, since the seed particles are not uniformly coated on the surface of the tubular support, it may cause problems. Specifically, the seed particles may be 0.05 parts by weight to 0.1 parts by weight.

Further, the suspension may be subjected to ultrasonic agitation or the like before impregnating the tubular support so that the seed particles in the suspension are more uniformly dispersed.

The calcination may be performed at 300° C. to 550° C. for 1 hour to 24 hours. By performing the calcination within the above-described range, the solvent that may be included in the seed particles is removed so that the surface of the seed particles may be well impregnated with the DDR precursor solution in the second growth step.

The second growth step may include adding a DDR precursor solution and a tubular support coated with the seed particles, and performing hydrothermal synthesis. In the DDR precursor solution, a zeolite crystal structure including the DDR structure is formed to surround the seed particles by hydrothermal synthesis, and subsequently it may be provided in the form of a film consisting only of the DDR structure by secondary growth.

In the method for manufacturing a CHA-DDR type zeolite membrane according to this embodiment, a CHA structure and a DDR structure, which are different crystal structures, may be formed by heteroepitaxial growth, and the CHA-DDR type zeolite membrane has the CHA structure therein, but it may be manufactured in the form of a film having the physical properties of the DDR structure as a whole.

In the first growth step, the seed particles may be provided in the form of a plurality of particles on a support. The support may include any one or more of α-alumina, γ-alumina, polypropylene, polyethylene, polytetrafluoroethylene, polysulfone, polyimide, silica, glass, mullite, zirconia, titania, yttria, ceria, vanadia, silicon, stainless steel, carbon, calcium oxide, and phosphorus oxide.

The support may be provided in a tubular shape having a high permeance of 1×10⁻⁶ mol·m⁻²·s⁻¹·Pa⁻¹ to 1×10⁻⁴ mol·m⁻²·s⁻¹·Pa⁻¹.

The seed particles are formed in plurality, and the seed particles may have an average length of 10 nm to 1 μm. If the seed particles has an average length of less than 10 nm, since the size of the seed particles is too small compared to the pores present on the surface of the support, a problem of inserting the seed particles into the support occurs, and thus there are problems in that it is difficult to form the seed particles, and it is difficult to uniformly form the first layer. In addition, when the seed particles has an average length of exceeding 1 μm, the size of the seed particles is too large so that there is a problem in that neighboring seed particles overlap with each other, and thus it is difficult to uniformly form a DDR structure. Specifically, the seed particles may be 100 nm to 1 μm, or 200 nm to 1 μm, or 200 nm to 700 nm, or 200 nm to 500 nm.

In the first growth step, the CHA precursor solution may include a first organic structure-directing agent, SiO₂, H₂O, a sodium compound, and an aluminum compound. For example, the sodium compound may include sodium oxide or sodium hydroxide, and specifically, may be Na₂O₃ or NaOH. In addition, the aluminum compound may include aluminum oxide or aluminum hydroxide, and specifically, may be Al₂O₃ or Al(OH)₃.

The first organic structure-directing agent, SiO₂, H₂O, the sodium compound, and the aluminum compound may have molar ratios of 0.1 to 1,000:100:100 to 50,000:0 to 500:0 to 100, respectively. Specifically, the first organic structure-directing agent, SiO₂, H₂O, the sodium compound, and the aluminum compound may have molar ratios of 1 to 100:100:500 to 30,000:5 to 50:0.5 to 20, more specifically 20:100:1,600:20:5, respectively.

The first organic structure-directing agent may be any one or more of N,N,N-trimethyl adamantylammonium hydroxide (TMAdaOH), N,N,N-trimethyl adamantylammonium bromide (TMAdaBr), N,N,N-trimethyl adamantylammonium fluoride (TMAdaF), N,N,N-trimethyl adamantylammonium chloride (TMAdaCl), N,N,N-trimethyl adamantylammonium iodide (TMAdaI), tetraethylammonium hydroxide (TEAOH), tetraethylammonium bromide (TEABr), tetraethylammonium fluoride (TEAF), tetraethylammonium chloride (TEACl), tetraethylammonium iodide (TEAI), dipropylamine, and cyclohexylamine.

The hydrothermal synthesis method may be performed for 6 hours to 400 hours and in a temperature range of 100° C. to 250° C. Specifically, the hydrothermal synthesis method may be performed at 140° C. to 180° C. for 100 hours to 200 hours.

The DDR precursor solution may include SiO₂, a second organic structure-directing agent, H₂O, a sodium compound, and an aluminum compound. For example, the sodium compound may include sodium oxide or sodium hydroxide, and specifically, may be Na₂O₃ or NaOH. In addition, the aluminum compound may include aluminum oxide or aluminum hydroxide, and specifically, may be Al₂O₃ or Al(OH)₃.

SiO₂, the second organic structure-directing agent, H₂O, the sodium compound, and the aluminum compound may have molar ratios of 100:1 to 1,000:10 to 100,000:0 to 500:0 to 100, respectively. Specifically, SiO₂, the second organic structure-directing agent, H₂O, the sodium compound, and the aluminum compound may have molar ratios of 100:10 to 800:500 to 30,000:0 to 50:0 to 20, more specifically 100:450: 11,240:0: 0, respectively.

The second organic structure-directing agent may be any one or more of methyltropinium iodide, methyltropinium bromide, methyltropinium fluoride, methyltropinium chloride, methyltropinium hydroxide, quinuclidinium, tetraethylammonium hydroxide (TEAOH), tetraethylammonium bromide (TEABr), tetraethylammonium fluoride (TEAF), tetraethylammonium chloride (TEACl), tetraethylammonium iodide (TEAI), ethylenediamine, and adamantylamine.

The hydrothermal synthesis method may be performed for 6 hours to 400 hours and at 100° C. to 250° C., and specifically, the hydrothermal synthesis method may be performed for 12 hours to 300 hours and at 100° C. to 200° C.

The CHA precursor solution and the DDR precursor solution may contain Si and Al, respectively, the CHA structure may have a Si:Al molar ratio reference value of 100:0 to 10, and the DDR structure may have a Si:Al molar ratio reference value of 100:0 to 10.

After the second growth step, a calcination step may be further included, and the calcination step may be performed in a temperature range of 100° C. to 300° C. in an ozone atmosphere.

The calcination in the ozone atmosphere may be performed at a temperature lower than that of the conventional calcination, and the second organic structure-directing agent that may be present in the pores of the CHA-DDR type zeolite membrane may be removed by the calcination step using the ozone atmosphere. In addition, since the calcination step according to this embodiment is performed in a low temperature range, it may be possible to prevent the formation of microcracks or the like that may occur due to different thermal behaviors between the support and the CHA-DDR type zeolite membrane. Accordingly, it may be possible to further improve the separation ability of mixed gases or the like.

The CHA-DDR type zeolite membrane may contain 1% by weight or less of 1-adamantylamine in the pores.

Hereinafter, Examples and Comparative Example of the present disclosure are described. However, the following Examples are only preferred embodiments of the present disclosure, and the scope of rights of the present disclosure is not limited by the following Examples.

### Manufacture of Examples and Comparative Example

### 1. Synthesis of SSZ-13 Particles and Formation of SSZ-13 Seed Layer on Tubular Support

A zeolite film was manufactured using an asymmetrical shaped α-alumina tubular support having high flux (outer diameter: 1.2 cm, thickness: 0.2 cm, length: 9 cm; Finetech Co., Ltd., Korea). The α-alumina tubular support contains β-alumina as an impurity at a very low level and consists mostly of α-alumina. Before synthesizing the zeolite film, both ends (about 2 cm) of the α-alumina tubular support used to seal the cell or module were gloss-treated with an impermeable material (IN1001 Envision Glazes, Duncan Ceramics, USA). After completion of the gloss treatment, SSZ-13 (standard oil synthetic zeolite-13, SSZ-13; chabazite (CHA) type) seed particles, which are zeolites including a CHA structure, were synthesized. The Si to Al ratio of the prepared SSZ-13 seed particles was shown to be 20±2 on average.

The prepared SSZ-13 seed particles were coated on the outer surface of the α-alumina tubular support by a dip coating method. Specifically, the prepared SSZ-13 seed particles were added to a 250 mL polypropylene (PP) bottle provided with ethanol, and then ultrasonicated for 20 minutes using an ultrasonic device (UC-10, JeioTech Co. Ltd., Korea) to prepare a suspension. The prepared suspension contained 0.75 g of seed particles per 1 L of ethanol. To apply the dip coating method, the suspension (approximately 50 mL) was moved and contained in a 50 mL graduated cylinder. At this time, the α-alumina tubular support was subjected to dip coating using a dip coater (ZID-6A, Jaesung Engineering Co., Republic of Korea).

The α-alumina tubular support was moved vertically downward to completely submerge in the suspension containing SSZ-13 seed particles. After being immersed for about 30 seconds, the α-alumina tubular support was lifted up and moved to the initial position and dried at room temperature for about 30 seconds. A seed layer composed of seed particles in the uniform and dense form was formed by repeating such dip coating a total of 14 times. Dip coating was performed 7 times in one direction of the α-alumina tubular support, and subsequently performed 7 times respectively in the other direction of the α-alumina tubular support by turning upside down the α-alumina tubular support. At this time, in order to prevent seed particles from being coated on the inner surface of the α-alumina tubular support, a parafilm (PM996, Bemis Co., Inc., USA) was attached to each bottom surface.

After the dip coating was completed, the α-alumina tubular support coated with the seed particles was separated from the dip coater and dried at room temperature for about 30 minutes. Subsequently, the α-alumina tubular support coated with the seed particles was put into a box-shaped furnace (CRF-M20-UP, Pluskolab, Republic of Korea), and fired at 450° C. for 4 hours by raising the temperature at 1° C./min.

### 2. Heteroepitaxially Grown DDR Membrane on SSZ-13 Seed Layer

Zeolite including a DDR (all-silica deca-dodecasil 3 rhombohedral, DDR; DDR form) structure was synthesized as follows.

Ethylenediamine (EDA; E26266, ≥99%, Sigma-Aldrich) was put into a PP reactor, and 1-adamantylamine (ADA; H30076, 98%, Alfa Aesar), an organic structure-directing agent (OSDA) for synthesizing zeolite of a DDR structure, was added thereto.

The PP reactor containing ethylenediamine and 1-adamantylamine was sonicated for 20 minutes to perform homogenization. After ADA was completely dissolved in EDA, deionized water (DI) was rapidly added to the mixture. Immediately after adding deionized water to the PP reactor, the solution became opaque and prepared into a suspension. Subsequently, the prepared suspension was mixed for 1 hour using a shaker machine (Si-300R, JeioTech Co. Ltd., Korea). After mixing was completed, the prepared suspension was put into an oil bath heated to about 95° C., and stirred using a magnetic bar for 3 hours until the opaque mixture became transparent. After heating the oil bath to about 95° C., the PP reactor was taken out of the oil bath, and then cooled by putting it into a bath containing ice water. While cooling the PP reactor, the solution was stirred for about 20 minutes using a magnetic bar. Subsequently, fumed silica (CAB-O-SIL M5, Cabot Corp., USA) was added into the cooled mixture. The prepared mixture was further mixed for 12 hours at room temperature using a shaker machine. The final molar composition of a DDR synthetic precursor prepared in this way was shown as 100:47: 404:11,240 (SiO₂:ADA:EDA:H₂O).

About 90 mL of the DDR synthetic precursor was added to a Teflon liner (total volume:about 120 mL). After that, the α-alumina tubular support coated with the seed particles was disposed to be tilted inside the Teflon liner. The Teflon liner was put into an autoclave made of stainless steel and sealed. The autoclave was transferred to a convection oven (PL_HV_250, Pluskolab, Korea) preheated to 160° C. and hydrothermal synthesis was performed under static conditions. After performing it for one day, the autoclave was quenched with tap water to stop the hydrothermal synthesis. After cooling the autoclave, the zeolite film sample synthesized on the tubular support was taken out and put into a 500 mL beaker filled with deionized water and washed for 12 hours. Subsequently, the sample was put into a dry oven (HB-502M, Pluskolab, Korea) at 70° C. and dried.

The dried tubular zeolite film was subjected to calcination by the following two methods, respectively. The two methods of calcination are divided into (1) air calcination in which the temperature of a box furnace is raised at 0.2° C./min and then calcined at 550° C. and for 12 hours with an air stream of 200 mL/min and (2) ozone calcination which is performed at 250° C. and for 40 hours with a 200 mL/min ozone (O₃) stream after raising the temperature of a quartz tube (outer diameter of 50 mm, wall thickness of 2 mm) in a tubular furnace (Scientech, Korea) at 0.2° C./min. At this time, the ozone stream was configured to contain 5 vol % of ozone to balance pure oxygen, and in particular, the ozone stream was generated by flowing pure oxygen gas (99.9% pure) at a rate of 1,000 mL/min in an ozone generator (OZE-020, Ozone Engineering Co., Ltd., Korea). Here, the manufactured tubular zeolite film form is referred to as a CD membrane, which means a DDR zeolite membrane grown heteroepitaxially from a SSZ-13 (CHA type) seed layer.

### 3. Synthesis of DDR@CHA Hybrid Particles

SSZ-13 zeolite particles were used as seed particles, and DDR structured zeolite (all-silica DDR zeolite) was synthesized through heteroepitaxial growth with a DDR synthetic precursor. The DDR synthetic precursor used the same material as the precursor used when synthesizing a CD film, which is the above-described tubular zeolite film.

The DDR synthetic precursor (about 30 mL) was put into a Teflon liner (total volume:about 45 mL), and SSZ-13 seed particles (about 0.03 g) were added thereto. The Teflon liner was put into a stainless steel autoclave and sealed. The stainless steel autoclave was put into a convection oven preheated to 160° C. The autoclave was rotated at about 45 rpm for 2 days to grow the seed particles. Subsequently, the stainless steel autoclave was quenched using tap water, thereby terminating the growth of seed particles.

After cooling the stainless steel autoclave, the synthesized particles were recovered using a centrifuge (Combi-514R, Hanil Science Industry Co., Ltd., Korea). Centrifugation, decanting, and washing of adding deionized water were repeatedly performed on the synthesized particles 5 times. The solid product obtained by this method was dried in a drying oven at 70° C.

As in the above-described CD membrane, the dried particles were thermally activated by performing calcination in the following two methods. The two methods of calcination are divided into (1) air calcination in which the temperature of a box furnace is raised at 1° C./min and then calcined at 550° C. and for 12 hours with an air stream of 200 mL/min and (2) ozone calcination in which the temperature of a tubular furnace (Scientech, Korea) is raised at 1° C./min and then calcined at 250° C. and for 40 hours with an ozone (O₃) stream (5 vol % ozone) of 200 mL/min. For convenience, the hybrid particles prepared in this way are referred to as CD-P, where C and D represent DDR zeolite grown heteroepitaxially from CHA-type seed particles and CHA zeolite seed particles, respectively, and P was attached to distinguish it from the above-described film form.

### 4. Characteristic Evaluation

SEM images were confirmed using a field emission scanning electron microscope (FE-SEM; S-4800, Hitachi Ltd., Japan). Before obtaining SEM images, each of the powder and membrane samples was coated with Pt using an E-1045 ion sputter (generated at 30 mA for 30 seconds) (Hitachi Ltd., Japan).

X-ray diffraction (XRD) patterns were confirmed using a D/Max-2500V/PC X-ray diffractometer (Rigaku Co., Japan) with CuKα radiation (λ=0.154 nm). For accurate comparison, simulated XRD patterns of CHA and DDR zeolites were checked using Mercury software (downloadable from the Cambridge Crystallographic Data Center website, http://www.ccdc.cam.ac.uk). Each crystal information file was downloaded and used from the International Zeolite Association (IZA) website (http://www.iza-online.org).

In addition, thermogravimetric analysis (TGA) results of CD-P particles were obtained using a Q50 (TA Instruments, USA) in an air environment.

In order to investigate the structural properties of the membrane using the heteroepitaxially grown CD film, cross-sectional specimens were prepared using a dual beam-focused ion beam scanning electron microscope (DB-FIB SEM; LYRA3 XMH, Tescan Orsay Holding, Czech Republic). Before cutting the cross-sectional specimens using DB-FIB SEM, carbon and platinum (Pt) were sequentially coated on the outer surface of the CD membrane to prevent damage due to beam. Thereafter, the cross-sectional specimens were prepared as very thin cross-sectional specimens having a thickness of about 100 nm using a gallium ion beam of DB-FIB SEM to be suitable for transmission electron microscopy (TEM) measurement. Cross-sectional TEM images, scanning transmission electron microscopy (STEM) images, and STEM-energy dispersive X-ray (EDX) data were confirmed using the prepared cross-sectional specimens. CHA structure (seed particles) and DDR structure (grown from seed particles) zeolite regions were confirmed through STEM microprobe mode. For this, FEI XFEG-Titan themis3 Double Cs & Monochromated TEM (Thermo Fisher Scientific Inc., USA) was used.

The internal defect structure of the hybrid CD membrane manufactured by performing calcination using fluorescence confocal optical microscopy (FCOM) in an air and ozone environment was confirmed. FCOM images of the hybrid CD membrane were obtained with a LSM 700 confocal microscope (Carl-Zeiss, Germany) using a solid-state laser (wavelength of 555 nm). CD membrane samples were dyed with fluorescein sodium salt (F6377, Sigma-Aldrich) as a dye molecule. The size of the dye molecule is approximately 1 nm, which is predicted to selectively access non-zeolite defects, whereas it was confirmed that the micropores of DDR zeolite (0.36×0.44 nm²) are maintained without being damaged.

Before measuring FCOM, the tubular CD membranes manufactured by performing air calcination and ozone calcination, respectively, were pulverized into small pieces. Subsequently, the prepared samples were immersed in an aqueous solution of 1 mM fluorescein sodium salt for about 4 days and dyed. After the dyeing was completed, the FOCM images of the dyed tubular CD membranes were checked depending on the thickness of the membranes. The obtained FOCM images were further processed to visually reconstruct the three-dimensional defect structure.

### 5. Measurement of Separation Performance

In order to measure the separation performance of the hybrid CD membrane, the separation performance for mixed gases of CO₂/CH₄ and CO₂/N₂ was confirmed while maintaining the total pressure of feed and permeate at about 1 bar and 0.03 bar, respectively. A vacuum pump (DTC-22B, Ulvac Technologies Inc., Japan) was used in order to keep the pressure low on the permeate side. To compare the separation performances, one CD membrane was mounted on a permeation cell (CD-1-Cell), and four CD membranes were mounted on a permeation module (CD-4-Module). FIG. 2 shows schematic forms of a cell and a module for evaluation of separation performances. FIG. 2 shows (a) one-CD membrane mounted cell (CD-1-Cell) and (b) four-CD membranes mounted module (CD-4-Module) for evaluating permeance and checking gas flow in the CO₂/CH₄ separation process.

Cells and modules used in order to measure separation performances were custom-made (Finetech Co., Ltd., Korea). The partial pressure of the CO₂/CH₄ binary mixture was shown as about 50.5 kPa:50.5 kPa (DRY CO₂:CH₄=50:50) under dry conditions, and the partial pressure of the CO₂/N₂ binary mixture was shown as about 15.2 kPa:85.8 kPa (DRY CO₂:N₂=15:85) under dry conditions. In addition, the separation performances were evaluated even under wet conditions. The partial pressures of CO₂/CH₄/H₂O and CO₂/N₂/H₂O ternary mixtures were about 49 kPa:49 kPa:3 kPa (WET CO₂:CH₄=50:50 and WET CO₂:N₂=50:50) and about 14.7 kPa: 83.3 kPa:3 kPa (WET CO₂:N₂=15:85), respectively.

The separation performances for CO₂/CH₄ and CO₂/N₂ were confirmed while changing the relative humidity from 26% to 100% at 50° C. The molar compositions of the binary mixtures of CO₂/CH₄ and CO₂/N₂ under both dry and wet conditions were 50% CO₂/50% CH₄ and 15% CO_{2/85}% N₂, respectively, based on a dry state.

A thermal mass flow rate controller (F-201CL, Bronkhorst, The Netherlands) was used to confirm the separation performance of the CD membrane by checking the recovery and purity while changing the total feed flow rate from 25 mL/min to 1,000 mL/min in the case of the CD-1-Cell and changing the total feed flow rate from 1,000 mL/min to 4,000 mL/min in the case of the CD-4-Module, respectively.

The log-mean average pressure drop was used to calculate the permeance considering the concentration gradient along the axial direction of the tubular CD membrane. CD-1-Cell and CD-4-Module were put into an oven (DX330, Yamato Scientific Co., Ltd., Japan), and the separation performances of CO₂/CH₄ and CO₂/N₂ at various temperatures were confirmed. Subsequently, the molar composition of the molecules on the permeate side was analyzed using gas chromatography (YL 6500 GC, Youngin Chromass, Korea). At this time, a vacuum pump was used to continuously inject molecules on the permeate side into a gas chromatograph having a thermal conductivity detector (TCD) mounted thereon. For precise measurement, N₂ (ca. 10 mL/min) was used as an internal standard for CO₂/CH₄ separation performance and CH₄ (ca. 10 mL/min) was used as an internal standard for CO₂/N₂ separation performance.

### Evaluation Results of Examples and Comparative Example

### 1. Properties of Heteroepitaxially Grown DDR@CHA Membrane

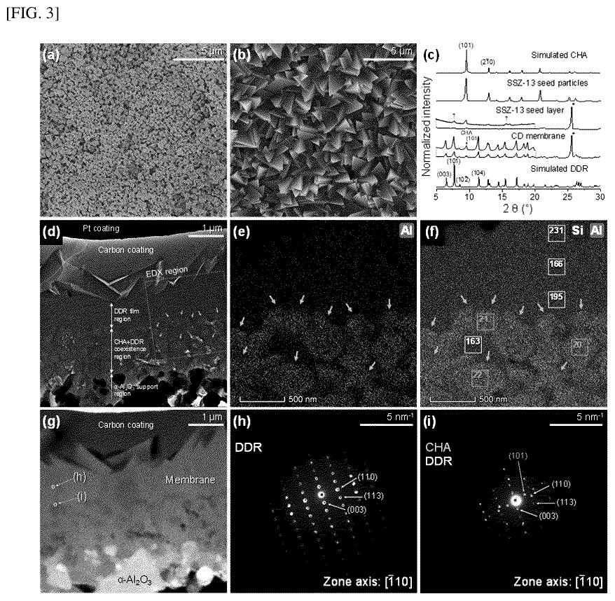

FIG. 3 shows SEM images, XRD patterns, a STEM image, and XRD patterns of the CD membrane according to this embodiment.

FIG. 3A shows a tubular α-Al₂O₃ support coated with SSZ-13 seed particles, FIG. 3B shows a SEM image of a DDR membrane (i.e., an ozone-calcined CD membrane or CD membrane) grown heteroepitaxially on an SSZ-13 seed layer, and FIG. 3C shows XRD patterns of SSZ-13 seed particles, seed layer, and CD membrane. The enlarged XRD patterns of the SSZ-13 seed layer and the CD membrane are shown as normalized XRD patterns. The simulated XRD patterns of CHA zeolite and DDR zeolite are shown at the top and bottom, respectively. In FIG. 3C, asterisks (*) and daggers (#) indicate XRD peaks of the composition of the support composed of α-Al₂O₃ (majority) and β-Al₂O₃(trace), respectively. FIG. 3D shows a cross-sectional TEM image of the FIB-treated CD membrane, and the chemical components of FIG. 3E (Al (gray)) and FIG. 3F (Si (white) and Al (grey)) accordingly. The images for the chemical compositions are for the quadrangular dotted line potions in FIG. 3D. Arrows in FIGS. 3D to 3F indicate SSZ-13 seed particles of the CD membrane. In FIG. 3F, the quadrangles indicated in white and gray represent the respective corresponding ratios of Si and Al. FIG. 3G is a cross-sectional STEM image of the sample indicated in FIG. 3D, and FIGS. 3H and 31 are XRD patterns obtained from the white circles indicated by h and i in FIG. 3G. In FIGS. 3H and 31, it was confirmed that the diffraction patterns (indicated by dots) measured by the [110] zone axis of the DDR zeolite were overlapped with the pattern obtained in the experiment. In addition, the diffraction pattern corresponding to CHA zeolite in FIG. 3I is indicated by a gray dot.

It was confirmed that SSZ-13 (CHA type) seed particles having a size of about 230 nm were uniformly coated on the outer surface of the asymmetric α-Al₂O₃ tubular support by dip coating (FIG. 3A). It could be confirmed that a CHA zeolite seed layer was formed by XRD analysis (FIG. 3C). Subsequently, the prepared CHA seed layer was grown heteroepitaxially using a synthetic precursor enabling DDR zeolite synthesis. It could be confirmed that the ozone-calcined CD membrane appeared in a continuous diamond shape (or pyramid shape) in the SEM image (FIG. 3B), and most of it consists of DDR zeolite in the XRD analysis of the portion corresponding to this (FIG. 3C). In particular, it could be confirmed that the shape such as a pyramid-shaped spike of FIG. 3B was similar to the particle shape of pure DDR zeolite. Even after the DDR zeolite grew on the CHA seed layer, it could be confirmed that the XRD peak of the (101) plane corresponding to the CHA zeolite appeared (FIG. 3C). Hereinafter, the heteroepitaxially grown zeolite membrane is referred to as a CD membrane, and C and D respectively represent CHA zeolite and DDR zeolite in the hybrid membrane.

In order to confirm the heteroepitaxially grown structure, a cross-sectional sample having a thickness of about 100 nm was prepared and subjected to TEM analysis. The cross-sectional TEM image of FIG. 3D clearly showed that two different portions were presented in the CD membrane having a total thickness of about 2 μm. Specifically, some spherical particles (portions indicated by arrows in FIG. 3D) were mainly observed at the boundary portion between the α-Al₂O₃ support and the CD membrane. In addition, the chemical components (portions the same as the dotted quadrangular marks in FIG. 3D) in FIGS. 3E and 3F showed higher Al contents than regions seen as portions grown from particles. In particular, the Al content-rich portions of the CD membrane appeared similar to the CHA seed particles in terms of the Si to Al ratio (Si/Al=20±2) and the shape and size (FIGS. 3A, and 3D to 3F). Meanwhile, the portions between and above the Al content-rich portions appeared to be highly siliceous as those grown by the DDR zeolite synthesis precursor.

A STEM image of the CD membrane was confirmed (FIG. 3G). Uniformly appearing portions were mainly observed on the upper portion of the CD membrane, and dark spots were mainly observed on the interface portion, and this was consistent with the TEM image of FIG. 3D. The XRD patterns were confirmed based on the STEM microprobe mode for the portions marked with white circles in FIG. 3G, and this confirmed an irregularly grown membrane (refer to FIG. 3H in which the portion marked by h in FIG. 3G is expanded, excluding dark spots), and seed particles (portions marked with i in FIG. 3G, dark spots). In particular, the electron beam was able to analyze various regions at high spatial resolution (approximately 50 nm accuracy) based on the STEM microprobe mode. The crystal structures of h and i were confirmed in the STEM image (FIG. 3G) by interpreting the XRD patterns of FIGS. 3H and 31, and it could be confirmed that these show secondary grown DDR zeolite and CHA seed particles, respectively.

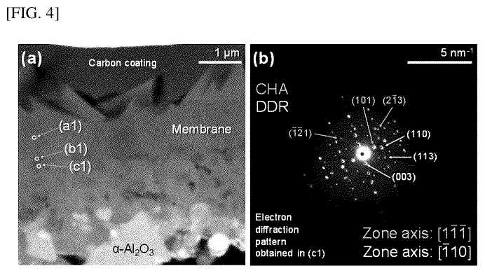

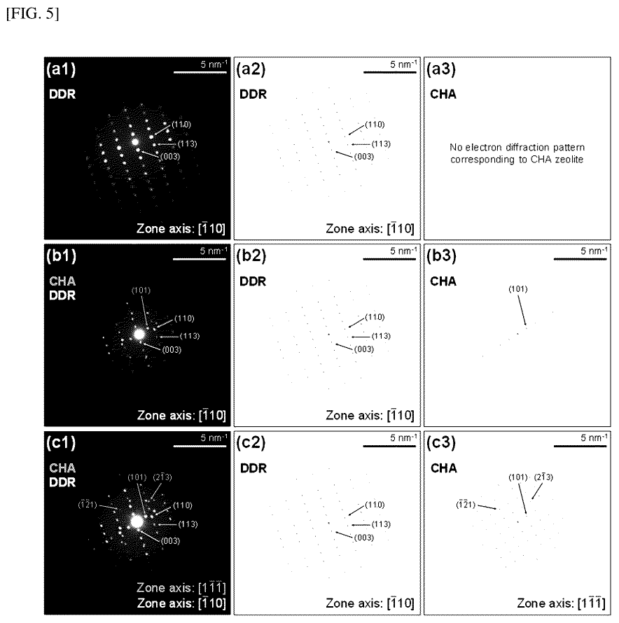

FIG. 4 shows a STEM image and an electron diffraction pattern of the CD membrane according to this embodiment. FIG. 5 shows electron diffraction patterns of the marked portion of the STEM image of FIG. 4.

In FIG. 4, FIG. 4A shows a STEM cross-sectional image (the same as that in FIG. 3G), and FIG. 4B shows an electron diffraction pattern at a portion marked as c1 in FIG. 4A. The portions indicated by a1 and b1 in FIG. 4A are the same as the portions indicated by h and i in FIG. 3G, respectively, and these are shown in FIGS. 3H and 31, respectively. In FIG. 4B, the portion indicated by the black dot that is at the inner side of the white dots corresponds to the (003), (110), and (113) planes of the [110] zone axis of the DDR zeolite. In addition, the portion corresponding to the CHA zeolite corresponds to the (121), (101), and (213) planes in the [111] zone axis.

In FIG. 5, FIGS. 5A1 to 5C1 show experimental values of the respective electron diffraction patterns for the portions corresponding to a1, b1, and c1 in FIG. 4A. FIGS. 5A2, 5B2, and 5C2 are DDR zeolites, and FIGS. 5A3, 5B3, and 5C3 show simulation results for CHA zeolite. In order to compare the experimental values and simulation results, they are disposed to correspond to each other in FIG. 5.

DDR zeolite was identified in the [110] zone axis in the electron diffraction patterns. In addition, an additional electron diffraction pattern appeared at position i, where it could be confirmed that the [110] zone axis for DDR zeolite appeared weak. Since the additional electron diffraction pattern is a portion that could not be explained by any plane of DDR zeolite, it could be found that it was derived from CHA zeolite (in particular, the point close to the center corresponds to the (101) plane mainly appearing in CHA zeolite). If the point moves further from the i position to the center of the dark spot, an additional electron diffraction pattern not corresponding to the DDR zeolite was confirmed (see FIG. 5). It was confirmed that some added points appeared in the CHA zeolite-based [111] zone axis.

Referring to FIGS. 3H and 31, and FIGS. 4 and 5, the results of the electron diffraction patterns according to the experimental results could also be confirmed by the simulated electron diffraction patterns. Although the electron diffraction patterns due to DDR zeolite and CHA zeolite could not be completely separated, newly appeared X electron diffraction patterns (i.e., “FIG. 5A1” to “FIG. 5C1” in FIG. 5) due to CHA zeolite can be confirmed as they approach the dark spots, which means that CHA zeolite and DDR zeolite coexist. Accordingly, the DDR zeolite can be heteroepitaxially grown in the CHA seed layer by structural compatibility, and as a result, it could be confirmed that the upper and lower regions of the membrane are divided into a DDR zeolite and a mixed layer of the DDR zeolite and the CHA zeolite, respectively.

### 2. Properties of DDR@CHA Hybrid Particles

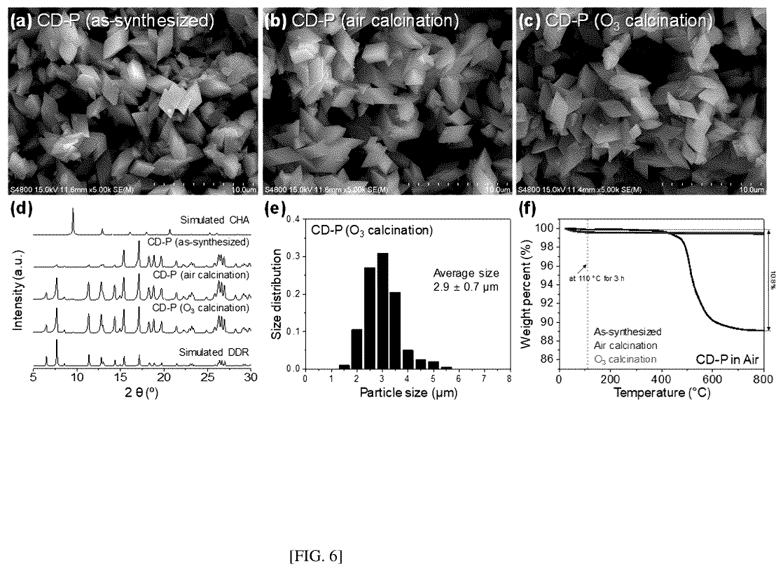

FIG. 6 shows SEM images and XRD patterns according to calcination conditions of CD-P particles according to the embodiment of the present disclosure. In FIG. 6, SEM images after (a) as-synthesized, (b) air calcination, and (c) ozone calcination are respectively shown. FIG. 6D shows the XRD patterns of as-synthesized, air calcined, and ozone calcined CD-P. The simulated XRD patterns of CHA zeolite and DDR zeolite are shown at the top and bottom, respectively. FIG. 6E shows the particle size distribution of the ozone-calcined CD-P. This was appeared in a diamond shape, and the longest length of each particle was measured. FIG. 6F is TGA results of the as-synthesized, air calcined, and ozone calcined CD-P. When measuring TGA of CD-P, after the temperature thereof in air was raised from room temperature to 110° C., it was maintained at 110° C. for 3 hours, and then the temperature thereof was raised to 800° C. again. At this time, the temperature was raised at a rate of 1° C./min.

CD-P particles were used for TGA in order to determine calcination conditions for the as-synthesized CD film. A method of growing the same seed particles in the synthesis of the CD membrane and CD-P particles is used, and therefore, the TGA results of the CD-P particles may be used as a basis for determining calcination conditions for the CD membrane. Here, as-synthesized means a state before calcination. The as-synthesized CD-P particles were subjected to air calcination and ozone calcination, respectively. FIG. 6 shows that the diamond shape of the CD-P particles is preserved regardless of calcination conditions. In addition, it could be confirmed that it was also consistent with the surface morphology of the CD membrane. It was confirmed that the CD-P particles subjected to air calcination at 550° C. and the CD-P particles subjected to ozone calcination at 250° C. had the same XRD pattern as the simulated XRD pattern of DDR zeolite in FIG. 6D. Accordingly, it means that the as-synthesized CD-P particles are mostly composed of zeolite having a DDR structure.

The average size of ozone-calcined CD-P particles was shown to be 2.9±0.7 μm. Considering that the thickness of the hybrid CD membrane is about 2 μm, which is similar to the size of the CD-P particles, the properties of the CD-P particles are predicted to be the same as those of the hybrid CD membrane. As a result of TGA of CD-P particles (i.e., the as-synthesized CD-P particles and the CD-P particles calcined in air conditions and ozone conditions, respectively), it could be confirmed that ADA present in the CD-P particles was completely removed by calcination.

In order to perform analysis in more detail, calcination was performed at 110° C. for 3 hours to remove moisture adsorbed on the zeolite particles. First, the TGA results of the as-synthesized CD-P particles showed that the weight portion of ADA (ca. 10.8% by weight) was similar to the theoretical value (ca. 11% by weight). This means that most of the CD-P particles were composed of zeolite having a DDR structure. In addition, the TGA results of air-calcined and ozone-calcined CD-P particles mean that ADA was completely removed after the as-synthesized CD-P particles were calcined at 550° C. and air conditions (air calcination) or 250° C. and ozone conditions (ozone calcination). Accordingly, it means that both of calcination methods may be suitably used even for the as-synthesized CD membrane.

Both thereof effectively removed ADA by the above-described air calcination at 550° C. or ozone calcination at 250° C. Meanwhile, in the case of a zeolite membrane synthesized at high temperatures, defects were formed due to a difference in the thermal expansion behavior between the zeolite membrane and the α-alumina support. Accordingly, the permselectivity of the manufactured zeolite membrane was reduced (here, CO₂/CH₄ SF 1.8 at 30° C. in dry conditions). Therefore, the permeation measurement was confirmed only for the ozone-calcined CD membrane. The zeolite pores of the CD film hardly formed defects, were thermally activated at a relatively low temperature of 250° C., and exhibited high separation performance.

### 3. Defect Structures of the CD Membranes

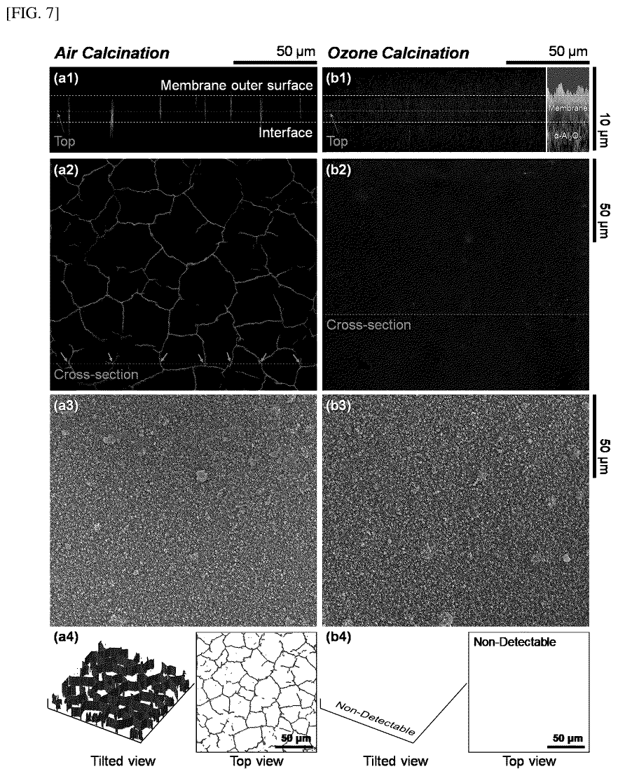

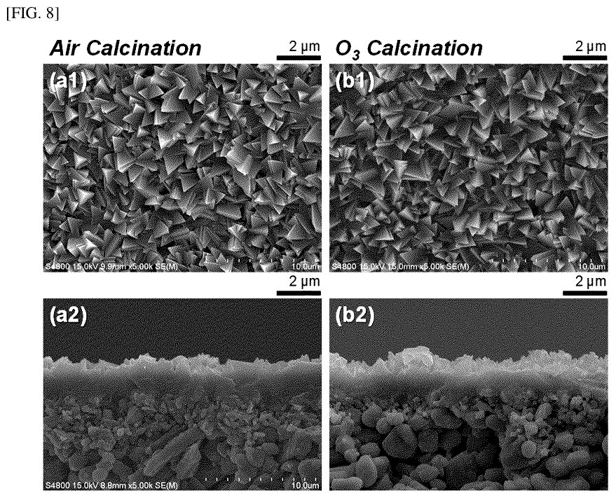

FIG. 7 is SEM images and FCOM images of CD membranes according to air calcination and ozone calcination, respectively. In FIG. 7, there are images of the CD membranes that were subjected to different calcination conditions respectively, such as air-calcined ones (FIG. 7A1 to FIG. 7A3) and ozone-calcined ones (FIG. 7B1 to FIG. 7B3). FIGS. 7A1 and 7B1 are FCOM images of the cross-sections, FIGS. 7A2 and 7B2 are FCOM images of the top, and FIGS. 7A3 and 7B3 are SEM images of the top. The FCOM images of the cross-sections correspond to the dotted line portions of the FCOM at the top. The dotted line in the FCOM images of the cross-sections indicated the location of the FCOM images at the top. In FIGS. 7A1 and 7B1, the white dotted lines at the top and bottom indicate the outer surface (top) of the CD membrane and the interface (bottom) between the CD membrane and α-Al₂O₃, respectively. Arrows in FIG. 7A2 indicate cracks observed in the cross-sections of the FCOM. In order to confirm the effects of air calcination (FIG. 7A4) and ozone calcination (FIG. 7B4), a tilted plane view three-dimensional image generated through image processing using FCOM images is shown. In FIG. 7B4 unlike FIG. 7A4, since the pixel corresponding to the defect was not detected and extracted by processing of the FCOM images, it was marked as “Non-Detectable”.

In the process of calcining the zeolite membrane at high temperatures, a defect structure, such as microcracks, may be formed in the zeolite membrane. Such microcracks may often act as a non-selective path in the process of separating mixed gases or the like, and thus may decrease the permselectivity of the membrane. This is caused by the difference in thermal behavior between the zeolite membrane and the α-Al₂O₃ support in the process of performing calcination at high temperatures. Meanwhile, in this embodiment, such defects may be prevented from being formed in the membrane by providing the ozone calcination performed at a relatively low temperature.

FIG. 8 is SEM images according to calcination conditions of a CD membrane. In FIG. 8, FIGS. 8A1 and 8B1 are top surfaces, and FIGS. 8A2 and 8B2 are SEM images showing cross-sections, respectively.

Experiments were performed using CD-P (where C is CHA seed particles, D is DDR zeolite in which the grown CHA seed particles are subjected to secondary growth after growing CHA seed particles, and P means a particle form) in the form of particles prepared by the above-described method. 1-adamantylamine (ADA) used as an organic structure-directing agent (OSDA) for the growth of seed particles of CD and CD-P was removed by air calcination and ozone calcination. In particular, it could be confirmed that CD-P was prepared under synthesis conditions similar to those of manufacturing of the CD membrane, and the size of CD-P was shown to be similar to the thickness of the CD membrane. Accordingly, the results of air calcination and ozone calcination confirmed by CD-P were applied to the CD membrane and confirmed.

FCOM analysis was used to visually confirm the defect structure of the CD membrane by air calcination and ozone calcination. It could be confirmed that the air calcination was performed at high temperatures, and microcracks, which are interconnected defect structures, were formed in the form of a network in the air-calcined CD membrane. Such a network of the microcracks was connected to the interface between the membrane and the α-Al₂O₃ support. The defect structure was shown to be similar to those of MTI-based homogeneous DDR and heteroepitaxially grown DDR@CHA membranes. Meanwhile, the CD membrane subjected to ozone calcination which was performed at a relatively low temperature did not show any defects.

Both of the CD membranes subjected to air calcination and ozone calcination, respectively, appeared similar in SEM images (FIGS. 7A3 and 7B3), but showed significant differences in defect structures in FCOM images (FIGS. 7A1, 7A2, 7B1, and 7B2). For detailed analysis, the FCOM images were processed into a three-dimensional image to confirm the defect structure (FIGS. 7A4 and 7B4). It could be confirmed that the defect structure was clearly observed in the air-calcined CD membrane, whereas it was hardly observed in the ozone-calcined CD membrane.

4. Evaluation of Separation Performances of CD Membranes from the Membrane Perspective

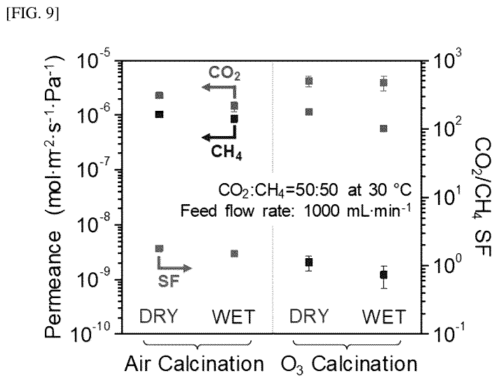

FIG. 9 is results of confirming CO₂/CH₄ separation performances of the CD membranes manufactured by air calcination and ozone calcination, respectively. Referring to FIG. 9, a CO₂/CH₄ binary equimolar mixture as a feed was measured at a feed flow rate of 1,000 mL/min under dry and wet conditions (water vapor pressure ca. 3 kPa) at 30° C. It could be confirmed that the ozone-calcined CD membrane was excellent in permeance and CO₂/CH₄ SF compared to the air-calcined CD membrane. As described above, it is determined that this is because microcracks are formed in the case of air calcination, and the microcracks provide a non-selective path in the process of separating the mixed gases.

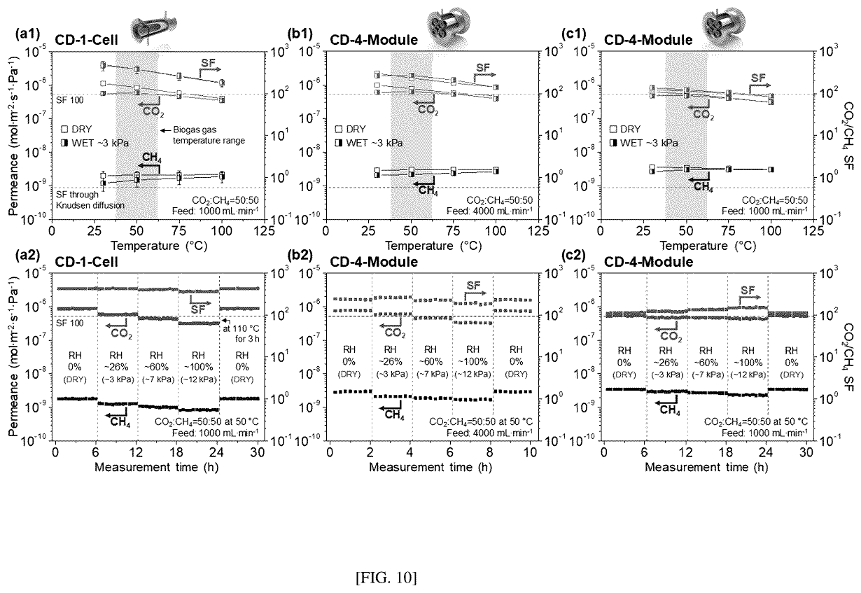

FIG. 10 is results of evaluating the separation performances of CO₂/CH₄ for CD-1-Cell and CD-4-Module. FIG. 10A1 is for CD-1-Cell with a feed flow rate of 1,000 mL/min, FIG. 10B1 is for CD-4-Module with a feed flow rate of 4,000 mL/min, and FIG. 10C1 is for CD-4-Module with a feed flow rate of 1,000 mL/min, and these are the results measured using a CO₂/CH₄ binary equimolar mixture under dry and wet conditions (ca. 3 kPa), respectively. In FIGS. 10A1 and 10C1, the temperature range related to biogas is shaded. With respect to CD-1-Cell with a feed flow rate of 1,000 mL/min (FIG. 10A1), CD-4-Module with a feed flow rate of 4,000 mL/min (FIG. 10B1), and CD-4-Module with a feed flow rate of 1,000 mL/min (FIG. 10C1), various relative humidities (RH) at 50° C. were confirmed as 0% (dry), up to 26%, up to 60%, and up to 100% (corresponding to water vapor pressures of 0, up to 3, up to 7, and up to 12 kPa, respectively), and a CO₂/CH₄ binary equimolar mixture was used as the feed. After performing the humidity test at ca. 12 kPa in wet conditions, the samples were dried at 110° C. for 3 hours and subsequently measured again at 50° C. in dry conditions.

In the case of the DDR zeolite, since CO₂ and CH₄ adsorption followed an almost linear behavior, it could be confirmed that the compositional changes in the mixed gases did not significantly affect each of the permeances. Meanwhile, when the feed flow rate was decreased from 4,000 mL/min to 1,000 mL/min, it could be confirmed that the separation performance of the CD-4-Module was deteriorated (FIGS. 10B1 and 10C1). It is determined that the decrease in the low feed flow rate is due to the polarization of CO₂ concentration in the radial direction (since CO₂ is a fast-permeating component) and/or the increase in the degree of CO₂ depletion in the bulk phase in the axial direction. This means that the performance of the CD membrane is greatly affected by different feed flow rates, and it could be confirmed that the application for this is necessary even in an actual membrane-based separation process.

The CO₂/CH₄ separation performances of CD-1-Cell and CD-4-Module were confirmed under wet conditions (water vapor pressure of about 3 kPa) (FIGS. 10A1 to 10C1). Water vapor is preferentially adsorbed on the outer and inner surfaces of the membrane at low temperatures to block the zeolite micropores, thereby hindering the movement of CO₂ molecules. The negative effect of water molecules adsorbed on the membrane decreases as the temperature increases to 100° C. As a result, under both of dry and wet conditions at 100° C., CO₂ permeance was high and CH₄ permeance was low, thus, high CO₂/CH₄ SF could be obtained regardless of the water vapor.

In particular, the CD membrane is composed entirely of a silica composition and has hydrophobicity, and even when water molecules are adsorbed, may have high CO₂ permselectivities even at low temperatures as the decrease in CO₂ permeance is maintained to be minimized. Specifically, in wet conditions, the maximum CO₂/CH₄ SF of CD-1-Cell was shown be as high as 476±121 at 30° C., and CO₂/CH₄ SF was well maintained (FIG. 10A1) even when water vapor is present in the feed at a temperature over the entire range up to 100° C. A typical temperature of the biogas stream is 25° C. to 60° C., and particularly in a recent tendency in which biogas production is required at approximately 50° C., it could be confirmed that the CO₂/CH₄ separation performance measured by the CD-1-Cell at 50° C. according to the present disclosure was shown to be very high (CO₂ permeance of (5.9±0.7)×10⁻⁷ mol·m⁻²·s⁻¹·Pa⁻¹ (ca. 1,770 GPU) and CO₂/CH₄ SF of 383±82).

The CO₂ permeance and CO₂/CH₄ SF measured by the CD-4-Module at 50° C. were shown to be ca. 6.4×10⁻⁷ mol·m⁻²·s⁻¹·Pa⁻¹ (ca. 1,900 GPU) and 268 (FIG. 10B1), respectively. Especially at both of CD-1-Cell and CD-4-Module, the intrinsic CO₂ permselectivities were shown to be excellent at 100 or more in the temperature range of 30° C. to 100° C. (FIGS. 10A1 and 10B1). Accordingly, it means that the CD membrane of the present disclosure may effectively purify biogas at various temperatures regardless of the content of water vapor.

Even when the same CD membrane is used, CO₂ permselectivities may vary depending on the design of the cell or module. For example, the residual volume per the mounted membrane of a cell or module varies depending on the stream of the feed. Specifically, the empty volume allocated to one CD membrane in the CD-4-Module is about 2.5 times larger than that in the CD-1-Cell. Accordingly, the cell has a small volume compared to the module, and the stream of the feed passing through such a cell having a small volume has a high possibility that it is present near the outer surface of the membrane, and at the same time, a larger amount of CO₂ molecules is adsorbed on the outer surface of the membrane so that this may promote molecular transport and thus provide higher permeance.

As results of confirming the CO₂ permselectivities of CD-1-Cell and CD-4-Module by changing the relative humidity (about 26, 60, and 100% corresponding to 3, 7, and 12 kPa) at 50° C., both of the CO₂ and CH₄ permeances of CD-1-Cell decreased as the water vapor pressure was increased from 0 (i.e., DRY) to ca. 12 kPa, and this is determined to be because water molecules were mainly adsorbed and interfered with molecular transport.

Meanwhile, it could be confirmed that the displayed CO₂ permselectivities were maintained almost constant regardless of the relative humidity. Specifically, ca. 2.9×10⁻⁷ mol·m⁻²·s⁻¹·Pa⁻¹ at saturated water vapor pressure (ca. 12 kPa at 50° C.) was approximately ⅓ of the dry conditions, and it could be confirmed that inactivation was not significantly observed and well maintained. This is determined due to the hydrophobicity of the CD membrane.

As a result of the relative humidity test in the CD-4-Module (FIG. 10B2), the tendencies of CO₂ and CH₄ permeances to water vapor pressure were shown to be similar to those of the CD-1-Cell. Meanwhile, at a low feed flow rate of 1,000 mL/min, the relative humidity test results at the CD-4-Module showed similar CO₂ permeances under both of dry and wet conditions. This is because mass transfer is hindered by water molecules on the outer surface of the membrane at a low feed flow rate.

As described above, after the relative humidity test was completed, all of the used CD membranes were dried, and when the dried membranes were measured again in dry conditions, it could be confirmed that the separation performances of both CD-1-Cell and CD-4-Module were recovered (FIGS. 10A2 to 10C2). This means that the high CO₂ permselectivities remained almost constant regardless of the amount of water vapor up to the saturated water vapor pressure (about 12 kPa) at 50° C. similar to that of the actual biogas stream.

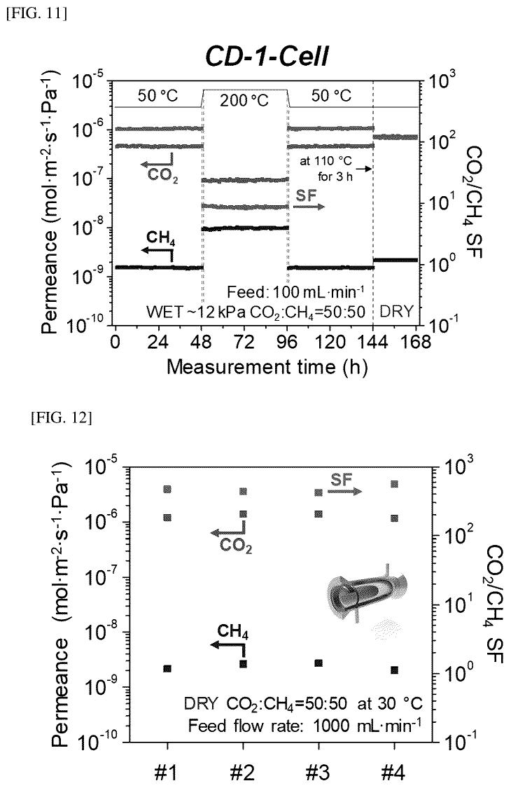

FIG. 11 is a result of confirming the long-term stability of CD-1-Cell.

In FIG. 11, a CO₂/CH₄ binary equimolar mixture as a feed was measured under wet conditions (saturated water vapor pressure of ca. 12 kPa) at a feed flow rate of 100 mL/min as feed, and the long-term stability was carried out at 50° C. for up to 4 days while performing it at 200° C. for up to 2 days in the middle was further confirmed. After confirming long-term stability under wet conditions (saturated water vapor pressure of ca. 12 kPa), drying was performed at 110° C. for 3 hours, and subsequently separation performance was confirmed again under dry conditions at 50° C.

Referring to FIG. 11, it was confirmed that the separation performance of the CD-1-Cell was maintained during the long-term stability test even under the conditions of saturated water vapor pressure at 50° C. In the present disclosure, it could be confirmed that the CO₂ permselectivities in the original dry conditions at 50° C. and 12 kPa were recovered after drying even though a harsh treatment was included at 200° C. for 48 hours in the middle in order to accelerate the degree of decomposition. Since the CD membrane according to the present disclosure is sufficiently robust, it may be easily applied in actual use.

As described above, when the air-calcined CD membrane is calcined at high temperatures, microcracks, which are defect structures, are formed therein. Accordingly, the separation performance may be reduced due to the microcracks in the process of separating the mixed gases or the like. Meanwhile, it could be confirmed that no defect structure was formed in the ozone-calcined CD membrane, and it exhibited better separation performance than the air-calcined CD membrane.

Thereafter, CD-1-Cell (FIG. 2A) and CD-4-Module (FIG. 2B) were each manufactured using the ozone-calcined CD membrane, and CO₂/CH₄ separation performance was confirmed in a state similar to actual use. In both of CD-1-Cell and CD-4-Module, it could be confirmed that CO₂ molecules preferentially passed through the CD membrane, and most of the CH₄ molecules could not pass through the CD membrane thus remained.

The separation performances of CD-1-Cell and CD-4-Module were also confirmed under wet conditions. Dry conditions are indicated by DRY, and wet conditions are indicated by WET. The maximum CO₂/CH₄ SF values in the dry conditions of CD-1-Cell and CD-4-Module were shown to be high at 498±93 and 300 at 30° C., respectively. In addition, the highest CO₂ permeance at 30° C. of CD-1-Cell was shown to be (1.2±0.1)×10⁻⁶ mol·m⁻²·s⁻¹·Pa⁻¹ (ca. 3440 GPU (gas permeance units)), and that of CD-4-Module was shown to be ca. 1.0×10⁻⁶ mol·m⁻²·s⁻¹·Pa⁻¹ (ca. 3,000 GPU). In particular, as the temperature increased, the permeances of CO₂ and CH₄ molecules monotonically decreased and remained almost constant, and CO₂/CH₄ SF monotonically decreased.

FIG. 12 is results of showing permeance and SF of a CO₂/CH₄ binary equimolar mixture for a plurality of CD membranes. In FIG. 12, the measurement was performed under dry conditions at 30° C. at a feed flow rate of 1,000 mL/min. As for the separation performance of the CD membrane, it was confirmed that the method of CD-1-Cell corresponded to that of CD-4-Module.

The CO₂/CH₄ separation performance was confirmed at 30° C. in dry conditions. For the reliability of the results, the separation performance was confirmed by using a plurality of membrane samples under each of the calcination conditions. The ozone-calcined CD membrane exhibited excellent CO₂ permselectivities in dry conditions. This is determined due to the absence of defects in the membrane during the ozone calcination.

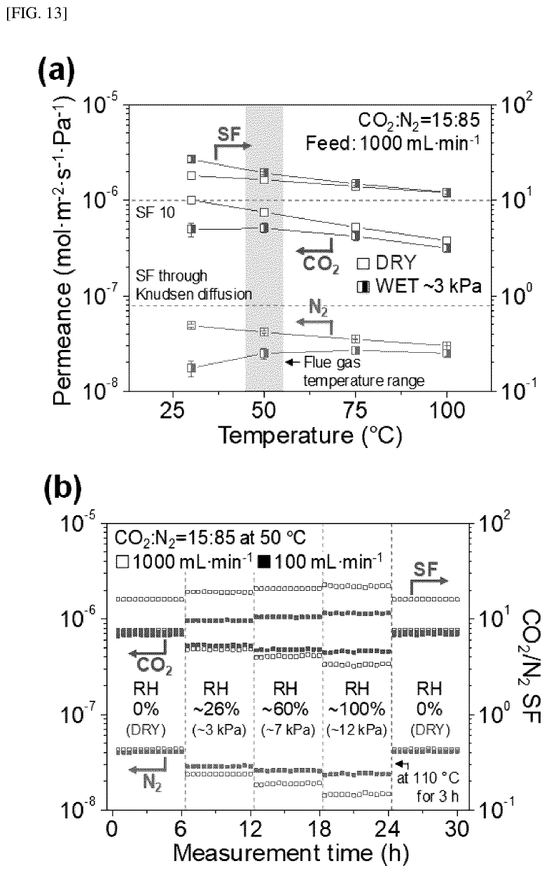

FIG. 13 is results showing the separation performance of CD-1-Cell for a CO₂/N₂ mixture. FIG. 13A shows permeance and SF, respectively, using the CO₂/N₂ biphasic mixture (15% CO₂ and 85% N₂) fed to the CD-1-Cell at a feed flow rate of 1,000 mL/min as a function of temperature under dry and wet conditions (ca. 3 kPa). Permeance and SF are shown respectively. In FIG. 13A, the temperature range of post-combustion flue gas generated in a coal-burning plant was set. In FIG. 13B, relative humidity (RH) tests at 50° C. at the feed flow rates of 1,000 mL/min and 100 mL/min are confirmed at various conditions, 0% (DRY), up to 6%, up to 60%, and up to 100% (corresponding to water vapor pressures of 0, up to 3, up to 7, and up to 12 kPa, respectively), respectively. After performing the humidity test under wet conditions (ca. 12 kPa), the samples were dried at 110° C. for 3 hours, and then the separation performance was tested again at 50° C. under dry conditions.

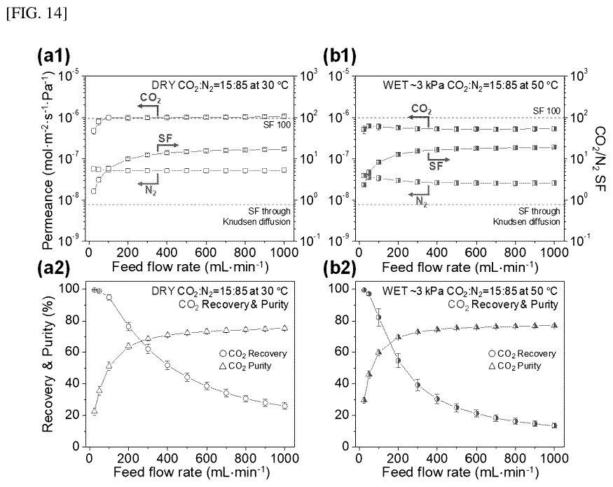

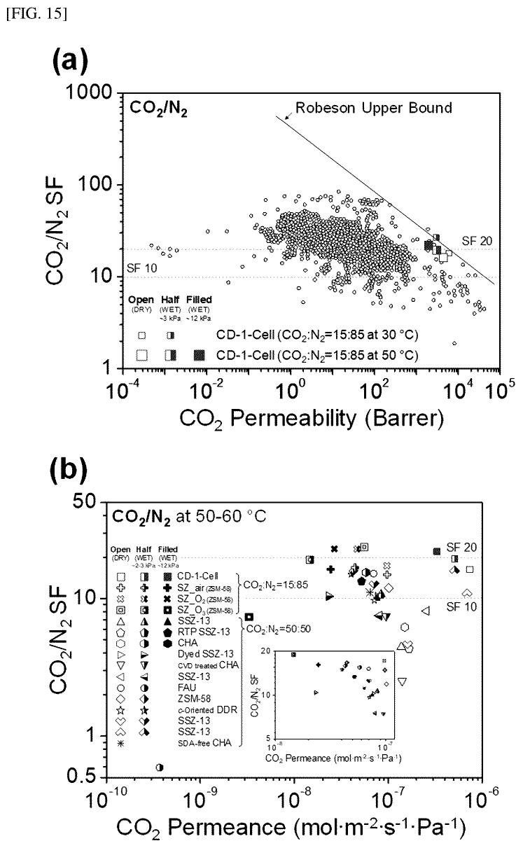

FIG. 14 shows results of showing the separation performances of CD-1-Cell for a CO₂/N₂ mixture under dry and wet conditions. Permeance and SF of a CO₂/N₂ biphasic mixture to the feed (15% CO₂ and 85% N₂) were confirmed at dry conditions and at 30° C. (FIG. 14A1) and at wet conditions (ca. 3 kPa) and 50° C. (FIG. 14B1), respectively. The recovery (circle) and purity (triangle) of CO₂ on the permeate side of the CD-1-Cell were shown, respectively.

The CO₂/N₂ separation performance results of CD-1-Cell for post-combustion flue gas flow (15% CO₂ and 85% N₂) were confirmed. The CO₂ permselectivities of the CD-1-Cell were measured at a flow rate of 1,000 mL/min for each of the dry and wet conditions (FIG. 13A). The maximum CO₂ permeance and CO₂/N₂ SF under dry conditions at 30° C. were shown as about 1.0×10⁻⁶ mol·m⁻²·s⁻¹·Pa⁻¹ (ca. 3,000 GPU) and 18.0±0.6, respectively. The maximum CO₂/N₂ SF under wet conditions was shown as 26.7±1.7 at 30° C. In addition, the maximum CO₂ permeance under dry conditions was shown as about 5.1×10⁻⁷ mol·m⁻²·s⁻¹·Pa⁻¹ (ca. 1,540 GPU) at 50° C. (typical temperature of the post-combustion flue gas flow in a coal-fired power plant), and further, the CO₂/N₂ SF at the same temperature was 19.4±0.6.

In general, the tendencies of CO₂ permeances as a function of temperature in dry and wet conditions were shown similar to those confirmed for equimolar CO₂/CH₄ separation performance. Meanwhile, the molecular sieving effect of the 8-membered-ring DDR zeolite (0.36×0.44 nm²) was shown large in CO₂/CH₄ separation performance since the kinetic diameter of the CH₄ molecule (0.38 nm) was shown slightly larger than that of the N₂ molecule (0.364 nm). Therefore, the permeance of N₂ was higher than that of CH₄ so that CO₂/N₂ SF was shown lower than CO₂/CH₄ SF.

In addition, the CO₂/N₂ separation performance of the CD-1-Cell was confirmed while changing the relative humidity to various relative humidities (relative humidities of 0%, up to 26%, up to 60%, and up to 100% corresponding to the water vapor pressures of 0, up to 3, up to 7, and up to 12 kPa) for each of two feed flow rates of 100 mL/min and 1,000 mL/min at 50° C. (FIG. 13B). As the water vapor pressure increased, it could be confirmed that water molecules were adsorbed onto the CD-1-Cell, and mass transport is deteriorated by the adsorbed water molecules so that CO₂ and N₂ permeances decreased. In particular, it could be confirmed that CO₂ and N₂ permeances decreased at 100 mL/min, which is a feed flow rate lower than 1,000 mL/min. Meanwhile, the CO₂ permeance of the CD membrane at high feed flow rates was well maintained at a level of about 44% of the CO₂ permeance of the dry conditions even in the saturated water vapor state of 12 kPa at 50° C.

The reason for the difference in the degree of reduction is determined to be due to the different degrees of water vapor contacting the outer surface of the membrane at different feed flow rates. It is determined that this is because the amount of water molecules delivered to the outer surface of the membrane in the feed flow decreases as the feed flow rate decreases, and accordingly, the suppression effect by water vapor is reduced.

Comparing the effect of relative humidity on the CO₂/CH₄ separation performance, the CO₂/N₂ SF monotonically increased as the relative humidity increased at both of low and high feed flow rates. The increased CO₂/N₂ SF in wet conditions showed the effect of adsorbed water molecules to be greater when transporting N₂ molecules (0.364 nm) than when transporting CH₄ molecules (0.38 nm), and this is because the permeance was already very low under dry conditions due to the performance of the molecular sieve of DDR zeolite (0.36×0.44 nm²). In particular, CO₂/N₂ SF was shown high at 11.4 and 21.9 for feed flow rates of 100 mL/min and 1,000 mL/min, respectively, at 50° C. and at a saturated water vapor of 12 kPa. It could be confirmed that CO₂/CH₄ separation performance, and CO₂/CH₄ separation performance under wet conditions and real conditions of a feed flow rate including CO₂ exhibit higher effects than when water vapor as a feed was present in the hydrophobic hybrid CD membrane.

Further, the CO₂/N₂ separation performance was confirmed for various feed flow rates (25 to 1,000 mL/min) under dry conditions at 30° C. and wet conditions (ca. 3 kPa) at 50° C. (representative temperature of a post-combustion flue flow). Referring to FIGS. 14A1 and 14B1, the tendency of CO₂/N₂ separation performance was shown similar to that of CO₂/CH₄ separation performance under dry and wet conditions. Specifically, it could be confirmed that the CO₂ permselectivities in dry and wet conditions increased as the feed flow rate increased to approximately 200 to 300 mL/min, and some reached asymptotic values at high feed flow rates. The only difference between the dry and wet conditions shown in FIGS. 14A1 and 14B1 is the decrease in CO₂ permeance due to adsorbed water molecules.

CO₂ recovery and purity (representative of module or process properties) of CD-1-Cell at various feed flow rates are shown in FIGS. 14A2 and 14B2. As the feed flow rate increased, the CO₂ purity increased, whereas the CO₂ recovery decreased under both of dry and wet conditions. This was shown similar to the tendency observed during CO₂/CH₄ separation under dry and wet conditions. Meanwhile, the recovery and purity results for the CO₂/N₂ separation were shown to be slightly different from those for the CO₂/CH₄ separation.

As a result of checking the total feed flow rate, the CO₂/N₂ SF was shown lower than the CO₂/CH₄ SF, and the CO₂ purity in the CO₂/CH₄ separation in each of the dry and wet conditions was shown to be 90% or more in the total feed flow rate. As the feed flow rate increased to 25 to 1,000 mL/min, the CO₂ purity in the CO₂/N₂ separation was shown to be increased from 22.5% to 75.3% under dry conditions, it was shown to be increased from 29.6% to 77.0% under wet conditions, and it could be confirmed that an asymptotic value of about 70% to 77% was reached after the feed flow rate of 300 to 400 mL/min.

Accordingly, the CD membrane was able to maintain a CO₂ purity of 60% or more at a feed flow rate of 200 mL/min. In addition, the amount (15%) of CO₂ molecules in the feed in the CO₂/N₂ separation is lower than the amount (50%) of CO₂ molecules in the CO₂/CH₄ separation so that the amount of CO₂ molecules recovered is shown almost 100% at low feed flow rates. Meanwhile, as the feed flow rate increased, the CO₂ recovery decreased, and it could be confirmed from this that the recovery of the fast permeance component is properties related to the intrinsic properties of the membrane (diffusion permeance through the membrane) and the properties of the feed stream (mass transfer from the bulk phase to the outer surface of the membrane).

Referring to FIG. 14A2, the CO₂/N₂ separation performance achieved simultaneous recovery and purity of approximately 60% to 70% at a feed flow rate of 200 to 300 mL/min.

Although CO₂/N₂ SFs under wet conditions had exhibited improved properties even when the intersection of recovery and purity was shifted to lower feed flow rates by the presence of water vapor, CO₂ molecule migration was limited by adsorption of water molecules. Accordingly, in the CO₂/CH₄ separation performance, it was confirmed that the separation performance should be evaluated through a comprehensive understanding considering the recovery and purity, which are properties from the viewpoint of the module or process, along with the permeance and CO₂/CH₄ SF, which are properties from the viewpoint of the membrane.

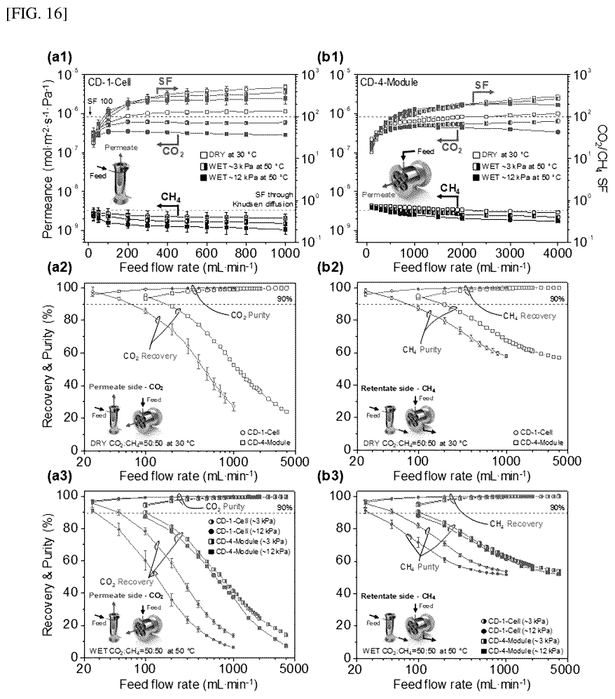

FIG. 15 is results showing the separation performance of CD-1-Cell for a CO₂/N₂ mixture according to temperature conditions. In FIG. 15A, the CO₂/N₂ biphasic mixture is a feed (15% CO₂ and 85% N₂) and the feed flow rate is 1,000 mL/min. Dry conditions are indicated by empty squares, wet conditions of up to 3 kPa are indicated by half-filled squares, and wet conditions of up to 12 kPa are indicated by full filled squares. In order to compare the separation performance with the polymer membrane (empty circle) in dry conditions, the Robeson upper limit value is indicated by a black line. FIG. 15B compares CO₂ permeance and CO₂/N₂ SF for CD-1-Cell and other zeolite membranes. The CO₂/N₂ biphasic mixture is a feed (15% CO₂ and 85% N₂), and dry conditions (empty squares) at 50° C. to 60° C., wet conditions (half-filled squares) of up to 2 to 3 kPa, and wet conditions (full filled squares) of up to 12 kPa were respectively confirmed. Permeance and SF were measured as a function of feed flow rate.

Referring to FIG. 15, the CO₂/N₂ separation performance of the CD membrane was compared with those of a polymer membrane and other zeolite membranes under dry and wet conditions. Specifically, the types of zeolite membranes used for comparison include, as shown in FIG. 15B, (1) DDR type: ZSM-58 and c-oriented DDR, (2) CHA type: SSZ-13, dye-post-treated SSZ-13, RTP SSZ-13, CHA, CVD-treated CHA, and SDA-free CHA, and (3) faujasite (FAU) type zeolites. In FIG. 15A, the CO₂/N₂ separation performance of the CD membrane according to the properties of the material appeared close to the Robeson upper bound, which is meant to exhibit excellent performance regardless of the content of water vapor contained in the feed. As described above, although there is no big difference between the molecular sizes (N₂: 0.364 nm vs. CH₄: 0.38 nm) of the permeation components of slow rates, it causes a high discrepancy for the CO₂ permselectivities.

Although it does not exhibit excellent performance in terms of material properties (FIG. 15A), the CD membrane exhibited better CO₂/N₂ separation performance than other zeolites in terms of CO₂ permeance and CO₂/N₂ SF (properties of a typical membrane) (FIG. 15B). The SSZ-13 membrane fabricated on a capillary tube exhibited high CO₂ permeance similarly to that of the CD membrane under dry and wet conditions, but CO₂/N₂ SF exhibited lower performance than the CD membrane. In addition, the FAU zeolite membrane exhibited a high CO₂/N₂ SF (about 15) under dry conditions, but when water vapor was contained in the feed, it could be confirmed that water molecules were preferentially adsorbed rather than CO₂ so that the performance was significantly deteriorated. In addition, the CD membrane exhibited excellent CO₂ permeance and CO₂/N₂ SF at 50° C. and a saturated water vapor pressure of ca. 12 kPa.

5. Evaluation of Separation Performances of CD Membranes from the Module Perspective, and their Correlation with Membrane Properties

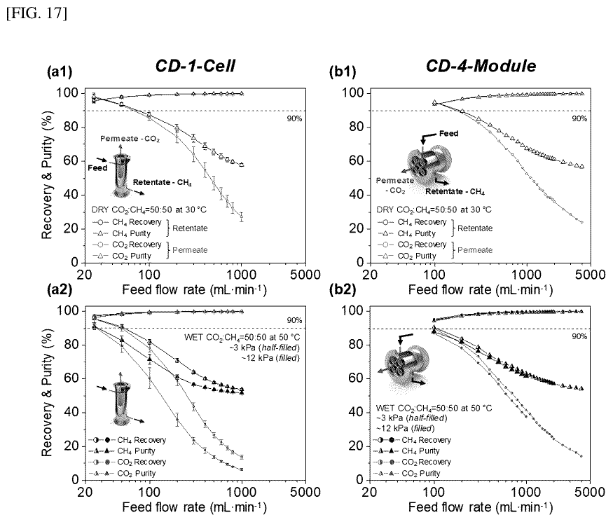

FIG. 16 is results of evaluating the separation performances of CO₂/CH₄ for CD-1-Cell and CD-4-Module. FIG. 17 is graphs showing the recovery and purity under dry and wet conditions of FIG. 16.

FIGS. 16A1 and 16B1 are permeance and SF measured as functions according to the feed flow rates of CO₂/CH₄ biphasic equimolar mixtures for CD-1-Cell and CD-4-Module, respectively, under dry conditions (empty squares), wet conditions (half-filled squares) of 30° C. and up to 3 kPa, and wet conditions (full-filled squares) of 30° C. and up to 12 kPa. FIGS. 16B2 and 16B3 show recoveries and purities of CO₂ and CH₄ on the permeate side and the retentate side, respectively, for CD-1-Cell (circle) and CD-4-Module (square) for the CO₂/CH₄ separation performances shown in FIGS. 16A1 and 16B1.

FIG. 17 shows the recovery and purity of CO₂ and CH₄ on the permeate side and the retentate side shown in FIGS. 16A1 and 16B1. The recovery and purity are shown as functions of flow rates for dry conditions of 30° C., wet conditions of 50° C. and up to 3 kPa (half-filled squares), and wet conditions of 50° C. and up to 12 kPa (full-filled squares).

Usually, unprocessed biogas stream contains water vapor in the range of approximately 3 to 12% of the saturated water vapor amount, and since such water vapor has a negative effect on CO₂ separation and biogas transport, there is a case in which a dehydration process is required to be additionally performed on biogas, which is a raw material. Therefore, in this embodiment, the CO₂/CH₄ separation performance of the CD membrane was measured under dry conditions of 30° C. and wet conditions (about up to 3 and up to 12 kPa) of 50° C., and the dried biogas streams subjected to the dehydration process, respectively, were used.

Separation performance was confirmed by changing the feed flow rate from 25 mL/min to 1,000 mL/min for CD-1-Cell and from 100 mL/min to 4,000 mL/min for CD-4-Module.

A membrane-based separation process was confirmed in terms of recoveries and purities of CO₂ on the permeate side (FIGS. 16A2 and 16A3) and CH₄ on the retentate side (FIGS. 16B2 and 16B3).

In FIG. 16A1, the CO₂ permeance ((1.0±0.1)×10⁻⁶ mol·m⁻²·s⁻¹·Pa⁻¹) under the dry conditions was maintained almost constant at a relatively high feed flow rate, whereas it decreased at ca. 300 mL/min, which is a relative low feed flow rate. On the contrary, the CH₄ permeance slightly increased as the feed flow rate decreased. Therefore, CO₂/CH₄ SF decreased slightly as the feed flow rate decreased, and it decreased rapidly at feed flow rates lower than ca. 300 mL/min.

The reduced CO₂ permeance at low feed flow rates is due to concentration polarization (i.e., radial direction) near the outer surface of the CD membrane and/or reduction of CO₂ molecules along the membrane length (i.e., axial direction). As such, due to the depletion of CO₂, CH₄ molecules are adsorbed on the outer surface of the membrane in increasing amounts, and thus the CH₄ permeance increases. In particular, the permeances of CO₂ and CH₄ under wet conditions were mainly reduced by water vapor. Nevertheless, the CO₂/CH₄ SF as a function of feed flow rate under wet conditions was similar to that under dry conditions, but the displayed CO₂ permeance (about 2.9×10⁻⁷ mol·m⁻²·s⁻¹·Pa⁻¹) showed favorable results even in practical application at 50° C. and a saturated water vapor pressure of 12 kPa. In addition, the separation performance of CD-1-Cell was shown similar to that of CD-4-Module in terms of the feed flow rate (FIG. 16B1). Meanwhile, the CO₂ permeance under dry conditions of CD-4-Module at the same feed flow rate was shown lower than that of CD-1-Cell, and the CH₄ permeance was shown higher than that of CD-1-Cell.

Such differences are attributed to the mass transfer between the CD-1-Cell and the CD-4-Module, since the CD-4-Module has a large volume so that it has a slow rate of transferring material to the outer surface of the membrane. The separation performance was shown very high at 50° C. and a saturated water vapor pressure of 12 kPa (FIGS. 16A1 and 16B1). The maximum CO₂/CH₄ SFs at 50° C. of CD-1-Cell and CD-4-Module were shown very high as 274±73 and 189, respectively.

Similarly to the results of high CO₂ permselectivities of CD-1-Cell and CD-4-Module, the respective CO₂ recovery and purity (FIGS. 16A2 and 16A3) and CH₄ recovery and purity (FIGS. 16B2 and 16B3) were shown to be about 100%. Meanwhile, the CD membrane showed a rather low CO₂ recovery at a high feed flow rate, and since the CO₂ recovery was low, the CH₄ purity on the retentate side was shown low. CO₂ permselectivities under both of the dry and wet conditions showed high CO₂ purity on the permeate side (90% or more in the total measured feed flow rate), but CO₂ recoveries under both of the dry and wet conditions decreased as the feed flow rate increased.

The recovery and purity of CH₄ on the retentate side were determined by CO₂ that preferentially passed through the CD membrane, and were shown similar to the recovery and purity of CO₂ on the permeate side. The CO₂ permselectivities were maintained at a high value due to the reduced CO₂ permeance due to the adsorption of water molecules, and the CO₂ recovery decreased as the water vapor pressure increased, whereas the CO₂ purity was maintained at 90% or more.

Increasing the number of membranes in a module may be effective in improving module capacity, but optimization requires deriving a correlation between module-based separation performance and dependent parameters of module configuration. Since the CO₂ permselectivities of the CD membrane are excellent (related to the purity of CO₂ on the permeate side), the effective recovery of CO₂ may increase the purity of CH₄ by increasing the module-based separation performance. Inherent CO₂ permeance and CO₂/CH₄ SF (representing the properties of the membrane) may be obtained at the highest feed flow rate (FIGS. 16A1 and 16B1), but it could be confirmed that the purity of CO₂ (permeance through the membrane) and the purity of CH₄ (blocked by the membrane and remaining in the feed) had dependency on the feed flow rate.

6. Evaluation of the Separation Performances of CD Membranes from the Perspective of Materials, Membranes, and Modules

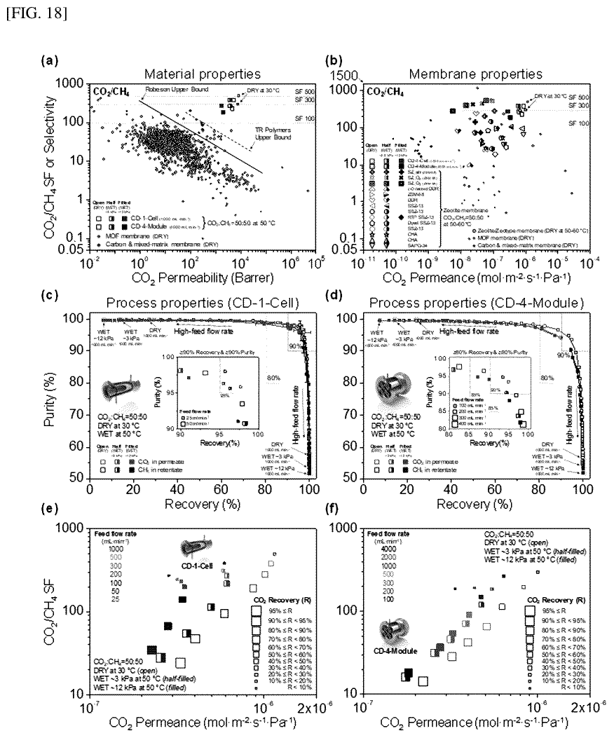

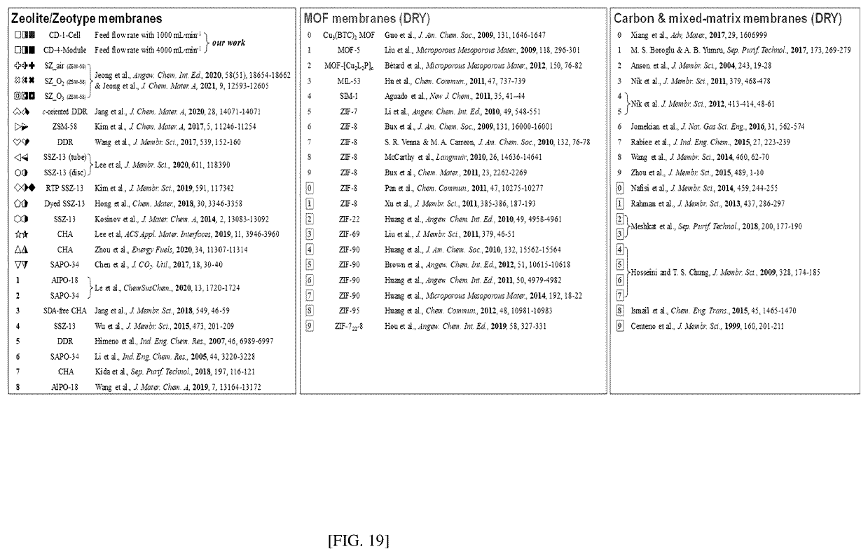

FIG. 18 is results of comparing performances of CD-1-Cell, CD-4-Module, and other membranes. FIG. 19 shows schematic features of the other membranes of FIG. 18.

FIG. 18A is CO₂ permeances and CO₂/CH₄ SFs (or selectivity) obtained at feed flow rates of 1,000 mL/min and 4,000 mL/min under dry conditions (empty squares) at 50° C., wet conditions (half-filled squares) of up to 3 kPa, and wet conditions (full-filled squares) of up to 12 kPa with respect to CD-1-Cell and CD-4-Module. FIG. 18B is CO₂/CH₄ SFs (or selectivities) for CO₂ permeances measured under dry conditions (empty squares) of 50° C. to 60° C., wet conditions (half-filled squares) of up to 3 kPa, and wet conditions (full-filled squares) of up to 12 kPa with respect to CD-1-Cell, CD-4-Module, and other zeolite/zeotype membrane. In particular, FIGS. 18A and 18B further included the separation performance of the CD membrane under dry conditions of 30° C. In FIG. 18A, the upper limits of Robeson and thermally rearranged (TR) polymers are indicated by black solid and dashed lines, respectively. FIGS. 18A and 18B include the performances of metal-organic framework (MOF) and carbon and mixed matrix membrane. In FIG. 18A, the performances of the polymer membranes were added, and in FIG. 18B, the performances of other zeolite/zeotype membranes were added. For CD-1-Cell (FIG. 18C) and CD-4-Module (FIG. 18D), the CO₂ recovery and purity of the permeate side and the CH₄ recovery and purity of the retentate side were confirmed according to the feed flow rate under dry conditions (empty squares) at 30° C., wet conditions (half-filled squares) of up to 3 kPa at 50° C., and wet conditions (full-filled squares) of up to 12 kPa, and the recovery and purity were shown to be 90% (FIG. 18C) and greater than 80% (FIG. 18D) in the enlarged areas, respectively. The functions of CO₂ permeance and CO₂/CH₄ SF for the feed flow rate were shown under dry conditions (empty squares), wet conditions (half-filled squares) of up to 3 kPa at 30° C., and wet conditions (full-filled squares) of up to 12 kPa of CD-1-Cell (FIG. 18E) and CD-4-Module (FIG. 18F). Here, the recovery is represented by the size of the symbol.

It can be confirmed in FIGS. 18A and 18B that the separation performance of the tubular CD membrane grown heteroepitaxially at 30° C. to 50° C. under dry and wet conditions is superior to or similar to that of other zeolite/zeotype membrane, and exhibits performance superior to those of the polymer membrane, the metal-organic frameworks, and the carbon and mixed matrix membranes.

In FIG. 18A, regardless of the presence or absence of water vapor in the feed, the CO₂/CH₄ separation performance of the CD membrane was found to exceed the upper limits of Robeson and thermally rearranged (TR) polymers when it was compared to those of other polymer membrane, metal-organic framework (MOF), carbon and mixed matrix membrane. In particular, the CD membrane had a high CO₂ permselectivities due to a molecular sieve-based cutoff and high CO₂ permeance. In addition, the CD membrane had hydrophobic properties and exhibited very high separation performance for a CO₂/CH₄ feed containing water vapor.

In order to evaluate the separation performance of the CD membrane in terms of the properties of the membrane in FIG. 18B, the CO₂/CH₄ separation performance of the CD membrane was compared with those of other zeolite/zeotype membrane under dry conditions (empty squares) at 50° C. to 60° C., wet conditions (half-filled squares) of up to 3 kPa, and wet conditions of up to 12 kPa (full-filled squares). Detailed information on the MOF, carbon and mixed matrix, and zeolite/zeotype membrane used in FIG. 18A is shown in FIG. 19.

The zeolite/zeotype membrane showed higher separation performance than those of the MOF, carbon and mixed matrix membrane. The CD membrane according to the present disclosure exhibited excellent CO₂/CH₄ separation performances under both of dry and wet conditions. In particular, even in a feed at 50° C. (about 12 kPa water vapor), both of CD-1-Cell and CD-4-Module showed significantly high CO₂ permeance and permselectivity compared to other zeolite/zeotype membrane (CD-1-Cell: CO₂ permeance 2.9×10⁻⁷ mol·m⁻²·s⁻¹·Pa⁻¹ and CO₂/CH₄ SF 274; CD-4-Module: CO₂ permeance 3.4×10⁻⁷ mol·m⁻²·s⁻¹·Pa⁻¹ and CO₂/CH₄ SF 189).

The CD membrane in this embodiment is made by combining a hydrophobic thin-type membrane (ca. 2 μm) and an asymmetric high-flux tubular support, and has rapid CO₂ permeation and high separation performance even at saturated water vapor pressure (ca. 12 kPa) at 50° C. SSZ-13 ( [symbol] ), CHA (Δ), and SAPO-34 (∇) membranes showed CO₂ permeances similar to that of the CD membrane according to this embodiment under dry conditions, but it could be confirmed that their CO₂ permeances were significantly deteriorated compared to that of the CD membrane under wet conditions (ca. 2 to 5 kPa). This means that the membrane made of hydrophobic DDR zeolite, which can maintain high separation performance regardless of the presence or absence of water vapor in the feed, exhibits excellent performance. In addition, the CO₂ permselectivity (CO₂/CH₄ SF 383 at 50° C.) of the CD membrane under wet conditions (ca. 2 to 5 kPa) was shown to be slightly lower than those (CO₂/CH₄ SF 398-446 at 50° C.) of the ZSM-58@CHA hybrid membrane (indicated by SZ_O3 and SZ_O2) fabricated on α-alumina disk support, but CO₂ permeance corresponding to this was very high (CO₂ permeance 5.9×10⁻⁷ mol·m⁻²·s⁻¹·Pa⁻¹).

Since high separation performance in terms of CO₂ permeance and permselectivity (representing membrane properties) is most important in practical applications, a CD membrane made of a tubular support is the most efficient in processing biogas. For the CD membrane-based CD-1-Cell and CD-4-Module, the experimentally obtained recovery and purity of CO₂ on the permeate side and CH₄ on the retentate side were plotted (FIGS. 17C and 17D). Separation performance in terms of module properties, which are closely related to the actual separation process, and separation performance in terms of membrane properties were compared. As verified previously, the intrinsic separation performance of the CD membrane in terms of permeance and permselectivity could be obtained at the maximum feed flow rate (FIGS. 17A1 and 17B1). Meanwhile, such a separation performance reflects high CO₂ purity (due to high CO₂ permselectivity) and low CO₂ recovery (due to CO₂ molar flux during the short residence time of the feed), and this exhibits high CH₄ recovery and low CH₄ purity on the retentate side. At this time, since the recovered CO₂ molecules are small, several separation steps should be passed through.

As the feed flow rate decreases, the CO₂ recovery gradually increases (right direction in FIGS. 17C and 17D), whereas high CO₂ purity is maintained. Accordingly, while the CH₄ recovery remains high, CH₄ purity increases as the feed flow rate decreases (upward direction in FIGS. 17C and 17D). Referring to the enlarged drawings inserted in FIGS. 17C and 17D, it can be confirmed that the recovery and purity of CO₂ and CH₄ are shown to be 90% or more for CD-1-Cell and more than 80% for CD-4-Module. In the case of a low feed flow rate in the range of 25 to 50 mL/min in the CD-1-Cell, the recovery and purity of CO₂ and CH₄ at 50° C. under wet conditions showed 90% or more at a water vapor pressure of ca. 3 kPa. In addition, when the feed flow rate was further reduced to 25 mL/min, the recovery and purity of CO₂ and CH₄ achieved 95% or more up to a water vapor pressure of ca. 3 kPa and 90% or more at a saturated water vapor pressure (ca. 3 kPa). In addition, CD-4-Module, which is capable of a higher feed flow rate compared to CD-1-Cell, may achieve 80% or more of the recovery and purity of CO₂ and CH₄ at a feed flow rate of 100 to 400 mL/min. In particular, the recovery and purity of CO₂ and CH₄ at a feed flow rate of 100 mL/min were shown to be 90% or more under dry and wet conditions (50° C. and about 3 kPa), and showed 85% of the recovery and purity of CO₂ and CH₄ in the case of a saturated water vapor pressure (about 12 kPa) at 50° C.

Separation performance in terms of CO₂ recovery (module properties) was compared those in terms of CO₂ permeance and permselectivity (membrane properties) for CD-1-Cell and CD-4-Module. Since CO₂ purity, which is closely related to permselectivity, is 90% or more in the entire range of feed flow rate (FIGS. 17C and 17D), only CO₂ recovery sensitive to feed flow rate was considered in FIGS. 17E and 17F. The highest separation performance was shown in terms of CO₂ permeance and permselectivity at the maximum feed flow rate, whereas it could be confirmed that CO₂ recovery was low under dry conditions (empty squares, 24 to 27%), wet conditions (half-filled squares, 14%) of up to 3 kPa, and wet conditions (full-filled squares, 6 to 7%) of up to 12 kPa. Accordingly, it could be confirmed that high permselectivity is required along with the optimal operation at the module level in order to perform effective separation.

As the amount of water vapor in the feed increased, the separation performance gradually decreased in terms of CO₂ permeance and permselectivity at a relatively high feed flow rate (i.e., in the lower left direction), and wet conditions (saturated water vapor of about 12 kPa) of 50° C. showed appropriate CO₂ permeance and permselectivity at the lowest feed flow rate, whereas it could be confirmed that CO₂ recovery and purity were shown to be high in CD-1-Cell (97% and 91%) and CD-4-Module (95% and 87%). This means that it is very important to properly evaluate the performance of a membrane in terms of module properties.

The CO₂/N₂ separation performance of the CD membrane was confirmed. In the separation performance, SFs were shown to be 18.0±0.5 and 26.7±1.7, respectively, under dry and wet conditions at 30° C. Meanwhile, the CO₂/N₂ separation performance was shown to be lower than that of CO₂/CH₄, and it is determined that the slight difference in molecular size (CH₄ 0.38 nm vs N₂ 0.364 nm) has a great effect on the permeance. In particular, the adsorption amount of CH₄ was shown to be higher than that of N₂ for the DDR zeolite (i.e., higher driving force for permeation), and the final CH₄ molar flux was shown to be very low. This is because the pores of the DDR zeolite may function as a molecular sieve more effectively for CH₄ permeation. Nevertheless, the CO₂/N₂ separation ability of the CD membrane according to this embodiment was shown to be significantly higher than that of other zeolite membranes.

In this embodiment as described above, a thin-type hybrid zeolite membrane having a thickness of 2 μm was manufactured as a CD membrane by performing secondary growth of DDR zeolite using 1-adamantylamine from a CHA zeolite seed layer. Air calcination and ozone calcination were performed on the manufactured CD membrane, respectively, and particularly, ozone calcination was performed at low temperatures, and it could be confirmed that no defect structure occurred within the DDR phase (0.36×0.44 nm²) in the manufactured CD membrane. Therefore, the ozone-calcined CD membrane exhibited particularly high performance during gas separation. The CD membrane exhibited very high CO₂ permselectivities (maximum CO₂/CH₄ SF 498±93 at 30° C.) via molecular sieving (kinetic diameters of CO₂ and CH₄ are 0.33 and 0.38 nm, respectively).

The DDR@CHA hybrid membrane was manufactured on a high-flux asymmetric α-Al₂O₃ support and exhibited high-flux CO₂ permselectivities (CO₂ permeance ((1.2±0.1)×10⁻⁶ mol·m⁻²·s⁻¹·Pa⁻¹) at 30° C. In particular, the high flux CO₂ permselectivities (CO₂ permeance of (5.9±0.7)×10⁻⁷ mol·m⁻²·s⁻¹·Pa⁻¹ and CO₂/CH₄ SF of 383±82) were shown even in a feed (corresponding to a biogas stream) containing water vapor at 50° C. due to the high hydrophobicity of the hybrid membrane made of continuous siliceous DDR zeolite.

In addition to confirming the separation performances in permeance and SF from the membrane perspective, the recovery and purity of CO₂ and CH₄ in both of the dry and wet conditions, which are closely related to the upgrading of biogas, were confirmed. In addition, the separation performances were compared and confirmed even from the perspective of the properties of the membranes and the modules (or processes). As a result, high CO₂ permselectivities are required to achieve high CO₂ purity, whereas it could be found that CO₂ permeance is intricately related to the CO₂ recovery as it is determined not only by the diffusion movement through the membranes, but also by the properties of the feed in the bulk phase. Accordingly, it could be confirmed that the recovery and purity of CO₂ molecules rapidly permeating on the permeate side are closely related to the recovery and purity of CH₄ molecules on the retentate side, and particularly, having a significant effect on the separation performances of the membranes in the module (or process) perspective.

### 7. Evaluation of Liquid Separation Performances of CD Membranes

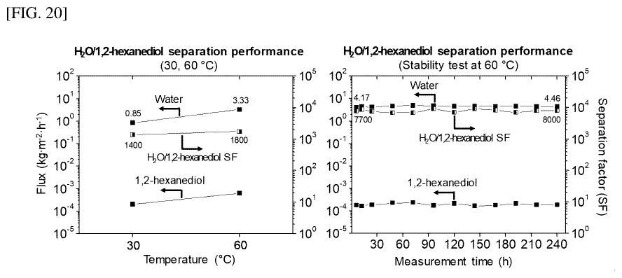

FIG. 20 is results of evaluating liquid separation performances using an ozone-calcined CD membrane.

In FIG. 20, the H₂O/1,2-hexanediol separation performances were evaluated using the ozone-calcined CD membrane, and the separation performances according to temperatures of 30° C. and 60° C. and the H₂O/1,2-hexanediol separation performances over time at 60° C. were confirmed, respectively. The H₂O/1,2-hexanediol mixture consisted of 75% by weight of water and 25% by weight of 1,2-hexanediol based on the weight.

It could be confirmed that dehydration was performed to water permeance of 0.85 kg·m⁻²·h⁻¹ and separation factor of 1,600 at 30° C. conditions, and it was performed to water permeance of 3.33 kg·m⁻²·h⁻¹ and high separation factor of 1,800 at 60° C. conditions, to a high purity. In particular, high 1,2-hexanediol dehydration performance was maintained stably for 240 hours even in a long-term stability test at 60° C. conditions.

In consequence, the CD membrane according to this embodiment can also separate water with high purity in addition to separating gas mixtures, and further, it could be confirmed that it can be used for a long time even at a high temperature of 60° C.

Those skilled in the art to which the present disclosure pertains will understand that the present disclosure can be embodied in other specific forms without changing its technical spirit or essential features. Therefore, the embodiments described above should be understood as illustrative in all respects and not limiting. The scope of the present disclosure is indicated by the scope of the claims to be described later rather than the detailed description above, and all changes or modified forms derived from the meaning and scope of the claims and equivalent concepts thereof should be interpreted to be included in the scope of the present disclosure.

1. A CHA-DDR type zeolite membrane comprising:
a first layer including a CHA structure and a DDR structure; and
a second layer which is provided on the first layer and includes a DDR structure,
wherein the CHA-DDR type zeolite membrane is in the form of a film having a thickness of 100 nm to 5 μm and includes a CHA structure and a DDR structure.

2. The CHA-DDR type zeolite membrane of claim 1, wherein the second layer includes a pyramid-shaped surface portion, and a (101) plane peak appears during XRD measurement using CuKα rays.

3. The CHA-DDR type zeolite membrane of claim 1, wherein the first layer has an average thickness of 50 nm to 2 μm, and the second layer has an average thickness of 10 nm to 2 μm.

4. The CHA-DDR type zeolite membrane of claim 1, wherein the CHA structure of the first layer is made of a CHA precursor solution, the CHA precursor solution contains a first organic structure-directing agent, SiO₂, H₂O, a sodium compound, and an aluminum compound, and the first organic structure-directing agent, SiO₂, H₂O, sodium compound, and aluminum compound have molar ratios of 0.1 to 1,000:100:100 to 50,000:0 to 500:0 to 100, respectively, and
the first organic structure-directing agent is any one or more of N,N,N-trimethyl adamantylammonium hydroxide (TMAdaOH), N,N,N-trimethyl adamantylammonium bromide (TMAdaBr), N,N,N-trimethyl adamantylammonium fluoride (TMAdaF), N,N,N-trimethyl adamantylammonium chloride (TMAdaCl), N,N,N-trimethyl adamantylammonium iodide (TMAdaI), tetraethylammonium hydroxide (TEAOH), tetraethylammonium bromide (TEABr), tetraethylammonium fluoride (TEAF), tetraethylammonium chloride (TEACl), tetraethylammonium iodide (TEAI), dipropylamine, and cyclohexylamine.

5. The CHA-DDR type zeolite membrane of claim 1, wherein the DDR structure of the first layer or the second layer is made of a DDR precursor solution, the DDR precursor solution contains SiO₂, a second organic structure-directing agent, H₂O, a sodium compound, and an aluminum compound, and SiO₂, second organic structure-directing agent, H₂O, sodium compound, and aluminum compound have molar ratios of 100:1 to 1,000:10 to 100,000:0 to 500:0 to 100, respectively, and
the second organic structure-directing agent is any one or more of methyltropinium iodide, methyltropinium bromide, methyltropinium fluoride, methyltropinium chloride, methyltropinium hydroxide, quinuclidinium, tetraethylammonium hydroxide (TEAOH), tetraethylammonium bromide (TEABr), tetraethylammonium fluoride (TEAF), tetraethylammonium chloride (TEACl), tetraethylammonium iodide (TEAI), ethylenediamine, and adamantylamine.

6. The CHA-DDR type zeolite membrane of claim 1, wherein the CHA-DDR type zeolite membrane has a carbon dioxide permeance of 1×10⁻⁹ mol·m⁻²·s⁻¹·Pa⁻¹ to 1×10⁻⁵ mol·m⁻²·s⁻¹·Pa⁻¹.

7. The CHA-DDR type zeolite membrane of claim 1, wherein the CHA structure is included in 25 parts by weight to 95 parts by weight based on 100 parts by weight of the total crystal structure of the CHA structure and the DDR structure of the first layer and the second layer.

8. The CHA-DDR type zeolite membrane of claim 1, wherein, when carbon dioxide and methane are mixed gases with a molar ratio of 50:50, carbon dioxide has a recovery of 10% to 100% and a purity of 50% to 100%, and methane has a recovery of 50% to 100% and a purity of 30% to 100%.

9. The CHA-DDR type zeolite membrane of claim 1, wherein, when carbon dioxide and nitrogen are mixed gases with a molar ratio of 15:85, carbon dioxide has a recovery of 10% to 100% and a purity of 20% to 100%, and nitrogen has a recovery of 30% to 100% and a purity of 30% to 100%.

10. The CHA-DDR type zeolite membrane of claim 1, wherein the CHA-DDR type zeolite membrane separates a mixture of gas and gas, a mixture of gas and liquid, and a mixture of liquid and liquid.

11. A method for manufacturing a CHA-DDR type zeolite membrane, the method comprising:
a first growth step of forming seed particles including a CHA structure prepared by a hydrothermal synthesis method using a CHA precursor solution containing a first organic structure-directing agent; and
a second growth step of forming a layered structure including a DDR structure to cover the seed particles by the hydrothermal synthesis method using a DDR precursor solution containing a second organic structure-directing agent,
wherein the CHA-DDR type zeolite membrane is in the form of a film having a thickness of 100 nm to 5 μm and includes a CHA structure and a DDR structure.

12. The method of claim 11, wherein the first growth step comprises
synthesizing the seed particles including the CHA structure by the hydrothermal synthesis method using the CHA precursor solution,
dispersing the seed particles in a solvent to prepare a suspension,
impregnating a support in the suspension to coat the surface of the support with the seed particles,
drying the support coated with the seed particles, and
calcining the support coated with the seed particles at 300° C. to 550° C. for 1 hour to 24 hours after completing drying, and
the second growth step comprises
adding the DDR precursor solution and the support coated with the seed particles and performing hydrothermal synthesis.

13. The method of claim 11, wherein in the first growth step, the seed particles are provided in the form of a plurality of particles on a support, and the support includes any one or more of α-alumina, γ-alumina, polypropylene, polyethylene, polytetrafluoroethylene, polysulfone, polyimide, silica, glass, mullite, zirconia, titania, yttria, ceria, vanadia, silicon, stainless steel, carbon, calcium oxide, and phosphorus oxide.

14. The method of claim 13, wherein the support is provided in a high permeance tubular shape with a permeance of 1×10⁶ mol·m⁻²·s⁻¹·Pa⁻¹ to 1×10⁻⁴ mol·m⁻²·s⁻¹·Pa⁻¹.

15. The method of claim 11, wherein the seed particles are formed in plurality, and the seed particles have an average length of 10 nm to 1 μm.

16. The method of claim 11, wherein
in the first growth step,
the CHA precursor solution contains a first organic structure-directing agent, SiO₂, H₂O, a sodium compound, and an aluminum compound,
the first organic structure-directing agent, SiO₂, H₂O, sodium compound, and aluminum compound have molar ratios of 0.1 to 1,000:100:100 to 50,000:0 to 500:0 to 100, respectively,
the first organic structure-directing agent is any one or more of N,N,N-trimethyl adamantylammonium hydroxide (TMAdaOH), N,N,N-trimethyl adamantylammonium bromide (TMAdaBr), N,N,N-trimethyl adamantylammonium fluoride (TMAdaF), N,N,N-trimethyl adamantylammonium chloride (TMAdaCl), N,N,N-trimethyl adamantylammonium iodide (TMAdaI), tetraethylammonium hydroxide (TEAOH), tetraethylammonium bromide (TEABr), tetraethylammonium fluoride (TEAF), tetraethylammonium chloride (TEACl), tetraethylammonium iodide (TEAI), dipropylamine, and cyclohexylamine, and
the hydrothermal synthesis method is performed for 6 hours to 400 hours and in a temperature range of 100° C. to 250° C.

17. The method of claim 11, wherein
in the second growth step,
the DDR precursor solution contains SiO₂, a second organic structure-directing agent, H₂O, a sodium compound, and an aluminum compound,
SiO₂, second organic structure-directing agent, H₂O, sodium compound, and aluminum compound have molar ratios of 100:1 to 1,000:10 to 100,000:0 to 500:0 to 100, respectively,
the second organic structure-directing agent is any one or more of methyltropinium iodide, methyltropinium bromide, methyltropinium fluoride, methyltropinium chloride, methyltropinium hydroxide, quinuclidinium, tetraethylammonium hydroxide (TEAOH), tetraethylammonium bromide (TEABr), tetraethylammonium fluoride (TEAF), tetraethylammonium chloride (TEACl), tetraethylammonium iodide (TEAI), ethylenediamine, and adamantylamine, and
the hydrothermal synthesis method is performed for 6 hours to 400 hours and at 100° C. to 250° C.

18. The method of claim 11, wherein
the CHA precursor solution and the DDR precursor solution each contain Si and Al,
the CHA structure has a Si:Al molar ratio reference value of 100:0 to 10, and
the DDR structure has a Si:Al molar ratio reference value of 100:0 to 10.

19. The method of claim 11, further comprising a calcination step after the second growth step,
wherein the calcination step is performed in a temperature range of 100° C. to 300° C. in an ozone atmosphere.

20. The method of claim 19, wherein the CHA-DDR type zeolite membrane contains 1% by weight or less of adamantylamine in pores thereof.
